(19) United States
(12) Patent Application Publication
(10) Pub. No.: US 2018/0101578 A1
(43) Pub. Date: Apr. 12, 2018

(54) EVALUATION METHOD AND APPARATUS

(71) Applicant: FUJITSU LIMITED, Kawasaki-shi (JP)

(72) Inventors: YUTAKA MITSUISHI, Kawasaki (JP); NOBUYUKI IGATA, Kawasaki (JP); Shinichiro Tago, Shinagawa (JP)

(73) Assignee: FUJITSU LIMITED, Kawasaki-shi (JP)

(21) Appl. No.: 15/718,667

(22) Filed: Sep. 28, 2017

(30) Foreign Application Priority Data
Oct. 6, 2016 (JP) 2016-198031

(51) Int. Cl. G06F 17/30

(52) U.S. Cl. CPC G06F 17/30528; G06F 17/30595

(57) ABSTRACT

An evaluation apparatus acquires estimated values of values indicating certain feature of a plurality of entities, respectively. Next, the evaluation apparatus determines, among the plurality of entities, entities, each of which is associated with the same value as a corresponding estimated value by specified relation information, to be first entities and holds the specified relation information. Next, the evaluation apparatus determines, among the plurality of entities, entities, each of which is associated with a value different from a corresponding estimated value by the specified relation information, to be second entities. Next, the evaluation apparatus calculates a concordance rate between the estimated values for the respective entities and the values associated with the respective entities by the specified relation information, based on the number of first entities and the number of second entities.

### CROSS-REFERENCE TO RELATED APPLICATION

This application is based upon and claims the benefit of priority of the prior Japanese Patent Application No. 2016-198031, filed on Oct. 6, 2016, the entire contents of which are incorporated herein by reference.

### FIELD

The embodiments discussed herein relate to an evaluation method and an evaluation apparatus.

### BACKGROUND

Various kinds of information is provided via networks. For example, provided information is described in Resource Description Framework (RDF) format. RDF is a standard for describing resources. Data described in RDF (RDF data) is provided by using a computer referred to as a Simple Protocol and RDF Query Language (SPARQL) endpoint, for example. The SPARQL endpoint searches and operates RDF data in response to a query described in an RDF query language referred to as SPARQL.

RDF data is represented by a set of elements including a subject, a property (a predicate), and an object. This set may be referred to as a triple. The subject and the property are each described by using a URI (Uniform Resource Identifier), and the object is described by using a URI or a literal. The literal is a character string or a numerical value, for example. In addition, when an object of a triple serves as a subject of another triple, a blank node without a URI may be used. A relationship among the elements of RDF data may be represented by a graph. For example, the URIs and the blank nodes are represented by circles or ovals, and literals may be represented by rectangles. An individual property indicating a relationship between a subject and an object is represented by an arrow connecting a circle and a rectangle.

RDF data could be used by an application software developer (hereinafter, simply referred to as a developer). For example, by using the SPARQL, the developer acquires certain RDF data from a SPARQL endpoint and creates a software program which performs processing that uses values included in the acquired RDF data. However, there are cases in which the RDF data do not include a value that the developer wishes to use (a value obtained by following a property path from a processing target URI). In this case, the developer creates a program module for estimating a value from one or more other values and uses the value estimated by the program module. For example, there are cases in which the RDF data only include values indicating full names of various persons while the developer wishes to use values indicating family names of the persons. In such cases, the developer creates a program module for estimating the family names from the full names.

The values estimated by the program module could include errors. Thus, this program module is used as an ad hoc program module. When target values are added to the RDF data in the SPARQL endpoint, the developer replaces the ad hoc program module by a program module for extracting the target values from the RDF data. For this purpose, it is important that the developer be promptly notified that the target values have been added to the RDF data in the SPARQL endpoint.

There are techniques for notifying developers that target values have been added to RDF data. For example, there is an information change reporting method that sets a reporting condition so that an appropriate volume of information is reported in response to information change. In addition, there is a system in which a network resource is dynamically monitored. In this system, after the network resource is updated, a user is notified of the update. There is also a technique that relates to storage of triples describing graph data in a decentralized storage environment. According to this technique, a trigger for performing notification or the like when a triple is accessed is given. In addition, there is a data storage system configured to store data encoding a data graph. In this system, a mechanism responds to a processing event at one of a plurality of resources by triggering execution of an event handler.

Japanese Laid-open Patent Publication No. 2008-158869

Japanese National Publication of International Patent Application No. 2012-529688

Japanese Laid-open Patent Publication No. 2013-175181

Japanese Laid-open Patent Publication No. 2015-156202

While these conventional techniques allow a developer to know addition of a value to a database holding data such as RDF data, it is difficult to determine whether the added value is a target value that the developer wishes to use.

### SUMMARY

According to one aspect, there is provided a non-transitory computer-readable storage medium storing a computer program that causes a computer to perform a procedure including: acquiring estimated values of values indicating certain features of a plurality of entities, respectively; referring to a database holding the plurality of entities, the values indicating the features of the respective entities, and one or more items of relation information indicating a relationship between the plurality of entities and the values indicating the features of the respective entities, determining the plurality of entities to be first candidate entities, sequentially selecting one of the first candidate entities, determining with respect to the selected first candidate entity whether the same value as a first estimated value for the selected first candidate entity is found by following the relation information, and when the same value as the first estimated value is found, determining the relation information that leads to the same value as the first estimated value to be specified relation information and determining the selected first candidate entity to be a first entity; referring to the database, determining, among the plurality of entities, entities other than first entities to be second candidate entities, sequentially selecting one of the second candidate entities, determining with respect to the selected second candidate entity whether a value different from a second estimated value for the selected second candidate entity is found by following the specified relation information, and determining, when a different value is found, the selected second candidate entity to be a second entity; and calculating a concordance rate between the estimated values for the respective entities and the values associated with the respective entities by the specified relation information, based on the number of first entities and the number of second entities.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example of a system according to a first embodiment;

FIG. 2 illustrates a configuration example of a system according to a second embodiment;

FIG. 3 illustrates a hardware configuration example of a property path candidate notification apparatus according to the second embodiment;

FIG. 4 is a block diagram illustrating functions of individual apparatuses according to the second embodiment;

FIG. 5 illustrates prefix definition examples;

FIG. 6 illustrates examples of RDF data stored in an RDF database;

FIG. 7 illustrates an example of a tuple table;

FIG. 8 illustrates an example of a property path calculation table;

FIG. 9 illustrates an example of a property path candidate table;

FIG. 10 is a flowchart illustrating an example of a procedure of RDF data utilization processing;

FIG. 11 is a flowchart illustrating an example of a procedure of family name value acquisition processing;

FIG. 12 is a flowchart illustrating an example of a procedure of tuple reception processing;

FIG. 13 illustrates a first update example of the RDF data;

FIG. 14 illustrates an example of a procedure of property path calculation processing;

FIG. 15 illustrates an example of a procedure of identical-value property path calculation processing;

FIGS. 16 and 17 illustrate an identical-value property path calculation example;

FIG. 18 is a flowchart illustrating an example of a procedure of different-value property path calculation processing;

FIG. 19 illustrates a different-value property path calculation example;

FIG. 20 is a flowchart illustrating an example of a procedure of coverage rate and match rate calculation processing;

FIG. 21 illustrates a coverage rate and match rate calculation example;

FIG. 22 conceptually illustrates a coverage rate and a match rate;

FIG. 23 illustrates an example of a procedure of notification processing;

FIGS. 24 and 25 illustrate coverage rate and match rate calculation results per data update;

FIG. 26 illustrates a property path notification determination example;

FIG. 27 illustrates a second update example of the RDF data;

FIG. 28 illustrates a coverage rate and match rate calculation example based on the second update example of the RDF data;

FIGS. 29 and 30 illustrate coverage rate and match rate calculation results per data update based on the second update example of the RDF data;

FIG. 31 illustrates a property path notification determination example based on the second update example of the RDF data;

FIG. 32 illustrates a third update example of the RDF data;

FIG. 33 illustrates a coverage rate and match rate calculation example based on the third update example of the RDF data;

FIG. 34 illustrates coverage rate and match rate calculation results per data update based on the third update example of the RDF data;

FIG. 35 illustrates a property path notification determination example based on the third update example of the RDF data;

FIG. 36 is a block diagram illustrating functions of individual apparatuses according to a third embodiment;

FIG. 37 illustrates an example of a search query table;

FIG. 38 illustrates an example of an additional URI table;

FIG. 39 is a flowchart illustrating an example of a procedure of reception processing;

FIG. 40 is a flowchart illustrating an example of a procedure of property path calculation processing according to the third embodiment;

FIG. 41 is a flowchart illustrating an example of a procedure of unknown-value property path calculation processing;

FIG. 42 illustrates an example of a result of the unknown-value property path calculation processing;

FIG. 43 is a flowchart illustrating an example of a procedure of coverage rate and match rate calculation processing according to the third embodiment;

FIG. 44 illustrates a coverage rate and match rate calculation example;

FIG. 45 illustrates a first comparison example between a coverage rate and a match rate according to the second embodiment and those according to the third embodiment;

FIG. 46 illustrates an example of a property path calculation table when a small number of values are added to the RDF data;

FIG. 47 illustrates a second comparison example between a coverage rate and a match rate according to the second embodiment and those according to the third embodiment;

FIG. 48 is a block diagram illustrating functions of individual apparatuses according to a fourth embodiment;

FIG. 49 illustrates an example of a search query and module table;

FIG. 50 illustrates an example of a temporary URI table;

FIG. 51 is a flowchart illustrating an example of a procedure of reception processing according to the fourth embodiment;

FIG. 52 is a flowchart illustrating an example of a procedure of property path calculation processing according to the fourth embodiment;

FIG. 53 is a flowchart illustrating an example of a procedure of tuple table generation processing; and

FIG. 54 illustrates a tuple table generation example.

### DESCRIPTION OF EMBODIMENTS

Hereinafter, embodiments will be described with reference to the accompanying drawings, wherein like reference characters refer to like elements throughout. An embodiment may be realized by combining a plurality of embodiments without causing contradiction.

### First Embodiment

First, a first embodiment will be described.

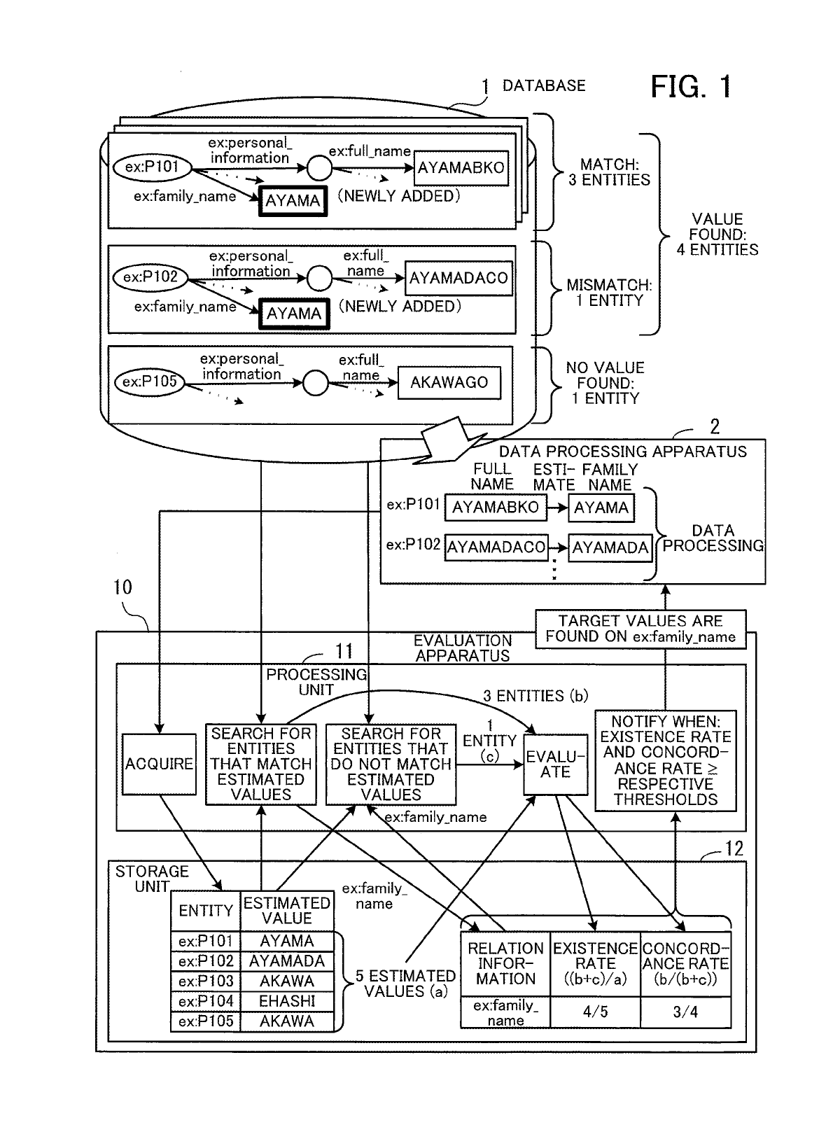

FIG. 1 illustrates a configuration example of a system according to a first embodiment. The system according to the first embodiment includes a database 1, a data processing apparatus 2, and an evaluation apparatus 10, which are connected to each other via a network or the like.

The database 1 holds a plurality of entities and a plurality of values indicating features of the respective entities. An entity and a value are associated with each other by one or more items of relation information. For example, an individual entity is a target element in the database 1 (a person, a place, an event, a concept, a service, etc.). For example, when RDF data is stored in the database 1, the subjects of the triples are entities. Each entity is expressed as a URI, for example. In the example in FIG. 1, “ex:P101,” “ex:P102,” etc. are the entities.

The data processing apparatus 2 is a computer that performs data processing by using data in the database 1. For example, the data processing apparatus 2 performs statistical processing by using values indicating features of entities. When a developer of a program for causing the data processing apparatus 2 to execute data processing recognizes that the database 1 does not include target values used for the data processing, the developer creates a program module for estimating the target values from other values. For example, the developer creates a program module for estimating the family names of persons from the full names of the persons. Next, the developer embeds the program module for estimating the values in the program for the data processing and causes the data processing apparatus 2 to execute the program module.

The evaluation apparatus 10 evaluates whether previously registered values associated with entities by specified relation information in the database 1 match values estimated by the data processing apparatus 2. To perform this evaluation, the evaluation apparatus 10 includes a processing unit 11 and a storage unit 12.

The processing unit 11 reads and writes data on the storage unit 12 and calculates evaluation values for evaluating whether registered values associated with entities in the database 1 match values estimated by the data processing apparatus 2. The storage unit 12 holds data used by the processing unit 11, such as relation information indicating a relationship between an entity and a value indicating a feature of the entity.

More specifically, first, the processing unit 11 acquires estimated values of values indicating certain features of a plurality of entities. For example, the data processing apparatus 2 estimates estimated values for a plurality of entities and transmits the estimated values to the evaluation apparatus 10. The transmitted estimated values are acquired by the processing unit 11.

Next, the processing unit 11 refers to the database 1 and determines the plurality of entities to be first candidate entities. Each of the first candidate entities is a candidate for an entity (a first entity) with which the same value as a corresponding estimated value is associated. For example, the processing unit 11 selects one of the first candidate entities, follows one or more items of relation information, and determines whether a value is found by following the relation information. Next, the processing unit 11 determines whether the value is the same as the estimated value for the first candidate entity (a first estimated value). When the value is the same as the estimated value, the processing unit 11 determines the relation information that leads to the same value as the first estimated value to be specified relation information. In addition, when the value is the same as the estimated value, the processing unit 11 determines the first candidate entity to be a first entity. The processing unit 11 performs this processing for all the first candidate entities. In addition, the processing unit 11 stores the specified relation information in the storage unit 12. For example, after the data processing apparatus 2 performs data processing using data in the database 1, when new values are associated with entities in the database 1, first entities are detected.

Next, the processing unit 11 refers to the database 1 and determines, among the plurality of entities, the entities other than the first entities to be second candidate entities. Each of the second candidate entities is a candidate for an entity (a second entity) with which a value different from a corresponding estimated value is associated by the specified relation information. When the processing unit 11 follows the specified relation information from an individual second candidate entity and finds a value different from a corresponding estimated value for the second candidate entity (a second estimated value), the processing unit 11 determines the second candidate entity to be a second entity.

In addition, the processing unit 11 calculates evaluation values. The evaluation values are, for example, a concordance rate and an existence rate. For example, on the basis of the number of first entities and the number of second entities, the processing unit 11 calculates a concordance rate between the estimated values for the respective entities and the values associated with the respective entities by the specified relation information. In addition, on the basis of the number of entities for which values are estimated, the number of first entities, and the number of second entities, the processing unit 11 may calculate an existence rate, which indicates the rate of the number of entities, each of which is associated with a value by the relation information, with respect to the number of the plurality of entities.

In addition, when the concordance rate and the existence rate satisfy certain conditions, the processing unit 11 notifies the data processing apparatus 2 of the specified relation information. For example, when the concordance rate is equal to or more than a predetermined threshold and the existence rate is equal to or more than a predetermined threshold, the processing unit 11 transmits a notification to the data processing apparatus 2. For example, the notification indicates that there is a possibility that values corresponding to values estimated by the data processing apparatus 2 (target values that the developer wishes to use) are associated by the relation information stored in the storage unit 12.

For example, when the evaluation apparatus 10 acquires estimated values of the family names of a plurality of persons from the data processing apparatus 2, the evaluation apparatus 10 associates the estimated values with the corresponding entities and stores the associated information in the storage unit 12. Next, the evaluation apparatus 10 searches the database 1 for entities associated with the estimated values of the family names by following specified relation information. When the evaluation apparatus 10 finds matching entities, the evaluation apparatus 10 determines these entities to be first entities. For example, the entity “ex:P101” is associated with a value “AYAMA” by relation information “ex:family_name.” This value matches the estimated value “AYAMA” associated with the entity “ex:P101” in the storage unit 12. Thus, the processing unit 11 determines the entity “ex:P101” to be a first entity and stores the relation information “ex:family_name” in the storage unit 12. In the example in FIG. 1, the processing unit 11 finds two more entities other than the entity “ex:P101,” as the entities associated with the respective estimated values by the relation information “ex:family_name.” Namely, the processing unit 11 finds three first entities.

Next, the processing unit 11 searches the entities other than the first entities for entities associated with values different from the respective estimated values by the relation information “ex:family_name.” When the evaluation apparatus 10 finds such entities, the evaluation apparatus 10 determines these entities to be second entities. In the example in FIG. 1, the entity “ex:P102” is associated with a value “AYAMA” by the relation information “ex:family_name.” This value is different from an estimated value “AYAMADA” associated with the entity “ex:P102” in the storage unit 12. Thus, the processing unit 11 determines the entity “ex:P102” to be a second entity. In the example in FIG. 1, only the entity “ex:P102” is a second entity.

Since the entity “ex:P105” is not associated with any value by the relation information “ex:family_name,” the entity “ex:P105” is neither a first entity nor a second entity.

Next, the processing unit 11 calculates a concordance rate and an existence rate. For example, the concordance rate is a value obtained by dividing the number of first entities by a sum of the number of first entities and the number of second entities. In the example in FIG. 1, the concordance rate is 3/4. For example, the existence rate is a value obtained by dividing a sum of the number of first entities and the number of second entities by the number of entities for which values are estimated. In the example in FIG. 1, the existence rate is 4/5.

For example, when both the concordance rate and the existence rate are equal to or more than their respective thresholds, the processing unit 11 notifies the data processing apparatus 2 of the relation information “ex:family_name.” By receiving the notification, the data processing apparatus 2 recognizes that the family name values are registered in the database 1. Thus, the developer of the program for the data processing apparatus replaces the program module for estimating values of family names by a program module for extracting values of family names from the database 1. As a result, the data processing apparatus 2 is able to perform data processing using more reliable values than estimated values.

In this way, since the evaluation apparatus 10 evaluates values in the database 1, for example, the evaluation apparatus 10 is able to evaluate whether new values added to the database 1 are target values that the data processing apparatus 2 is to use for its processing. When high evaluation is obtained, the evaluation apparatus notifies the data processing apparatus 2 that the database 1 includes the corresponding values. Thus, without having to always monitor whether the database 1 has been updated, the developer of the program for the data processing apparatus 2 is able to know addition of target values to be used. As a result, the developer's burden to monitor the update status of the database 1 is reduced.

Namely, if the developer is notified of the update status of the database 1 each time a new value is added to the database 1, the developer needs to determine whether the updated value is a target value to be used each time the developer is notified. Namely, much burden is imposed on the developer. In contrast, the evaluation apparatus 10 according to the first embodiment notifies the developer of whether values in the database 1 are target values to be used by the developer only when high evaluation is obtained. Thus, less burden is imposed on the developer.

In addition, by using the existence rate as well as the concordance rate as the evaluation values, only when a sufficient number of target values to be used by the developer, the number of target values being sufficient for statistical processing, are added to the database 1, the developer is notified of the addition of the target values. As a result, unnecessary notifications are further reduced.

The reduction of the unnecessary notifications leads to reduction of the processing load on the data processing apparatus 2 and the evaluation apparatus 10 and to reduction of the load on the network between the data processing apparatus 2 and the evaluation apparatus 10. For example, assuming that all the users of the database 1 are notified of addition of desired values, the larger the number of users is, the greater the advantageous effect of reducing the processing load on the evaluation apparatus 10 becomes by reducing the unnecessary notifications.

There are cases in which the processing unit 11 could not acquire a sufficient number of estimated values. To respond to such cases, the processing unit 11 may be configured to perform the following processing.

The processing unit 11 acquires a search query indicating a common feature of entities for which estimated values are acquired. Next, other than the entities for which estimated values have been acquired, the processing unit 11 detects additional entities that match the search query from the database 1. Next, the processing unit 11 refers to the database 1 and determines, among the additional entities, entities associated with values by specified relation information to be third entities. Next, the processing unit 11 calculates the existence rate on the basis of the number of the plurality of entities, the number of additional entities, the number of first entities, the number of second entities, and the number of third entities. For example, the processing unit divides a sum of the number of first entities, the number of second entities, and the number of third entities by a sum of the number of the plurality of entities and the number of additional entities and determines the obtained value to be the existence rate.

In this way, the processing unit 11 is able to calculate an existence rate by using a search query to detect the additional entities and third entities. Namely, even when estimated values for a sufficient number of entities are not available, the processing unit 11 is able to calculate a reliable existence rate.

In addition, there are cases in which the processing unit 11 could not acquire estimated values from the outside. To respond to such cases, the processing unit 11 may be configured to perform the following processing.

The processing unit 11 acquires a search query indicating a common feature of a plurality of entities and a program module for acquiring estimated values of values indicating certain features of the plurality of entities on the basis of values associated with the plurality of entities, respectively. More specifically, the processing unit 11 uses a search query to determine a plurality of entities in the database and executes the program module to acquire the estimated values for the determined respective entities.

Thus, since the processing unit 11 itself uses a program module to calculate estimated values, the processing unit 11 is able to calculate a reliable concordance rate without acquiring any estimated values from the data processing apparatus 2.

For example, the processing unit 11 may be realized by a processor of the evaluation apparatus 10. For example, the storage unit 12 may be realized by a memory or a storage device of the evaluation apparatus 10.

### Second Embodiment

Next, a second embodiment will be described. According to the second embodiment, whether values added to the RDF data in a SPARQL endpoint are target values that a developer wishes to use is evaluated. When evaluation values equal to or more than predetermined values are obtained, the developer is notified of addition of the target values.

The concordance rate and the existence rate described in the first embodiment will be referred to as a “match rate” and a “coverage rate” in the second embodiment, respectively.

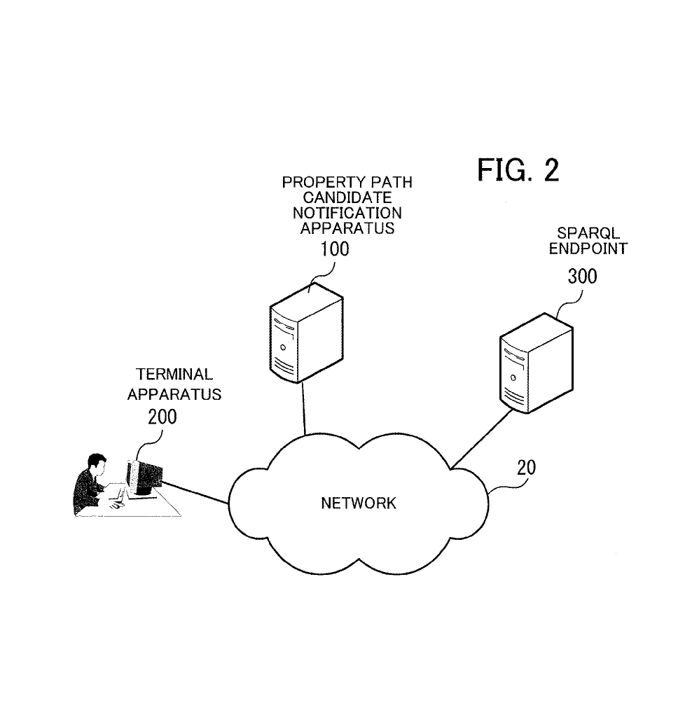

FIG. 2 illustrates a configuration example of a system according to the second embodiment. According to the second embodiment, a property path candidate notification apparatus 100, a terminal apparatus 200, and a SPARQL endpoint 300 are connected to each other via a network 20.

The property path candidate notification apparatus 100 is a computer that monitors addition of values to the RDF data in the SPARQL endpoint 300 and evaluates whether the added values are target values that a developer wishes to use. When evaluation values for the added values are equal to or more than predetermined values, the property path candidate notification apparatus 100 notifies the terminal apparatus 200 of a property path indicating the location of the values in the RDF data.

The terminal apparatus 200 is a computer that the developer uses to develop application software. The SPARQL endpoint 300 is a computer that holds the RDF data and provides the RDF data via the network 20.

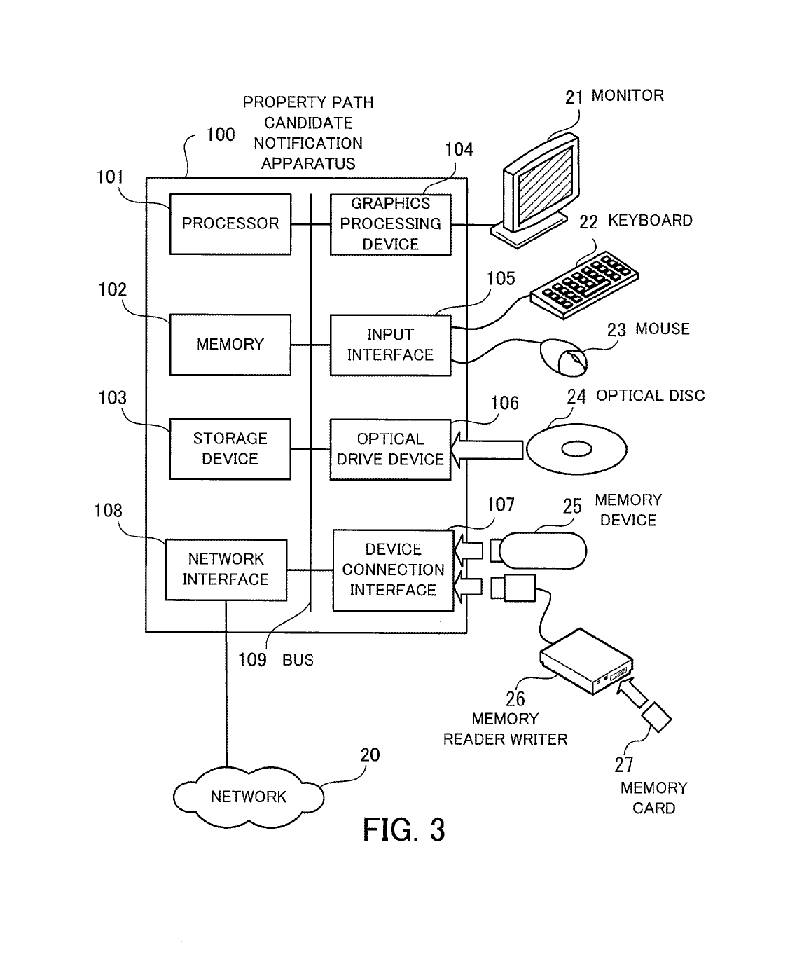

FIG. 3 illustrates a hardware configuration example of the property path candidate notification apparatus according to the second embodiment. The property path candidate notification apparatus 100 is comprehensively controlled by a processor 101. The processor 101 is connected to a memory 102 and a plurality of peripheral devices via a bus 109. The processor 101 may be a multiprocessor. Examples of the processor 101 include a central processing unit (CPU), a micro processing unit (MPU), and a digital signal processor (DSP). At least a part of the functions realized by causing the processor 101 to execute a program may be realized by an electronic circuit such as an application specific integrated circuit (ASIC) or a programmable logic device (PLD).

The memory 102 is used as a main storage device of the property path candidate notification apparatus 100. The memory 102 temporarily holds at least a part of an operating system (OS) program or application software executed by the processor 101. In addition, the memory 102 holds various kinds of data needed for processing performed by the processor 101. Examples of the memory 102 include a volatile semiconductor storage device such as a random access memory (RAM).

Examples of the peripheral devices connected to the bus 109 include a storage device 103, a graphics processing device 104, an input interface 105, an optical drive device 106, a device connection interface 107, and a network interface 108.

The storage device 103 electrically or magnetically reads and writes data on an internal storage medium. The storage device 103 is used as an auxiliary storage device of the property path candidate notification apparatus 100. The storage device 103 holds an OS program, application software, and various kinds of data. Examples of the storage device 103 include a hard disk drive (HDD) and a solid state drive (SSD).

The graphics processing device 104 is connected to a monitor 21. The graphics processing device 104 displays an image on a screen of the monitor 21 in accordance with a command from the processor 101. Examples of the monitor 21 includes a cathode ray tube (CRT) display device and a liquid crystal display (LCD) device.

The input interface 105 is connected to a keyboard 22 and a mouse 23. The input interface 105 transmits signals transmitted from the keyboard 22 and the mouse 23 to the processor 101. The mouse 23 is an example of a pointing device. Another pointing device may be used as the mouse 23. For example, another pointing device such as a touch panel, a tablet, a touchpad, or a trackball may be used as the mouse 23.

The optical drive device 106 uses laser light or the like to read data stored in an optical disc 24. The optical disc 24 is a portable storage medium in which data is stored to be read by light reflection. Examples of the optical disc 24 include a digital versatile disc (DVD), a DVD-RAM, a compact disc read-only memory (CD-ROM), and a CD-recordable (R)/rewritable (RW).

The device connection interface 107 is a communication interface for connecting peripheral devices to the property path candidate notification apparatus 100. For example, a memory device 25 and a memory reader writer 26 may be connected to the device connection interface 107.

The memory device 25 is a storage medium having a function of communicating with the device connection interface 107. The memory reader writer 26 is a device that reads and writes data on a memory card 27. The memory card 27 is a card-type storage medium.

The network interface 108 is connected to the network 20. The network interface 108 exchanges data with another computer or communication device via the network 20.

The above hardware configuration realizes processing functions according to the second embodiment. The apparatuses described in the first embodiment may also be realized by the same hardware configuration as that of the property path candidate notification apparatus 100 illustrated in FIG. 3.

For example, the property path candidate notification apparatus 100 realizes processing functions according to the second embodiment by executing a program stored in a computer-readable storage medium. This program may be stored in any one of various kinds of storage medium. For example, the program executed by the property path candidate notification apparatus 100 may be stored in the storage device 103. In this case, the processor 101 loads at least a part of the program stored in the storage device 103 to the memory 102 and executes the program. Alternatively, the program executed by the property path candidate notification apparatus 100 may be stored in a portable storage medium such as the optical disc 24, the memory device 25, or the memory card 27. For example, after the program stored in a portable storage medium is installed to the storage device 103 in accordance with a command from the processor 101, the program may be executed. The processor 101 may directly read the program from a portable storage medium and execute the program.

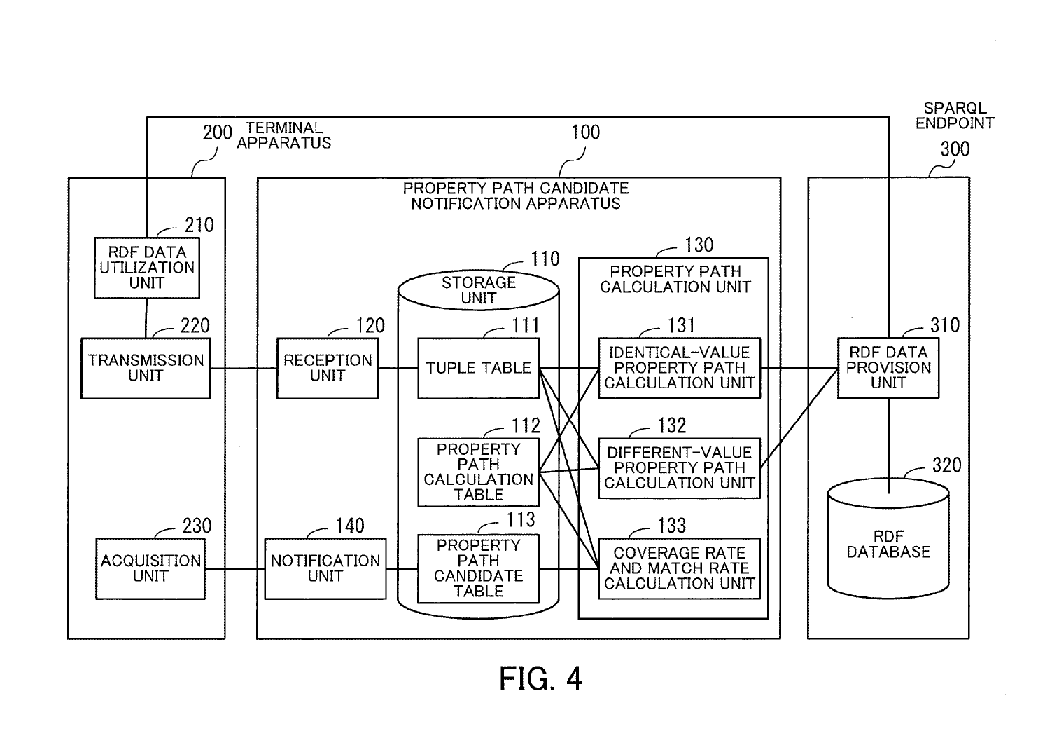

FIG. 4 is a block diagram illustrating functions of individual apparatuses according to the second embodiment. The property path candidate notification apparatus 100 includes a storage unit 110, a reception unit 120, a property path calculation unit 130, and a notification unit 140.

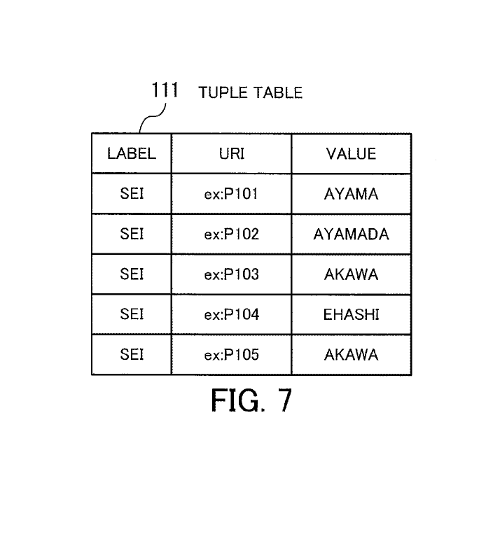

The storage unit 110 holds data used for determining a property path associated with target values that the developer wishes to use. As the storage unit 110, for example, a part of the storage area of the memory 102 or the storage device 103 is used. For example, the storage unit 110 holds a tuple table 111, a property path calculation table 112, and a property path candidate table 113. The tuple table 111 is a data table in which tuples are registered. The tuples include estimated values of target values that the developer wishes to use. The property path calculation table 112 is a data table in which the evaluation contents of individual values added to the RDF data are registered. The property path candidate table 113 is a data table in which evaluation values indicating whether values associated by a property path in the RDF data are target values that the developer wishes to use are registered. Details of each of the data tables will be described below with reference to FIGS. 7 to 9.

The reception unit 120 receives tuples each of which includes a label, a URI, and a value from the terminal apparatus 200 and registers the tuples in the tuple table 111. These tuples are specified by the developer as samples.

The property path calculation unit 130 calculates evaluation values indicating whether values associated by a property path in the RDF data are target values that the developer wishes to use. For example, the property path calculation unit 130 calculates the evaluation values regularly (once a day, for example) or each time the SPARQL endpoint 300 performs data update processing. The property path calculation unit 130 includes an identical-value property path calculation unit 131, a different-value property path calculation unit 132, and a coverage rate and match rate calculation unit 133.

The identical-value property path calculation unit 131 sequentially refers to one of the tuples in the tuple table 111 and determines whether the URI in a tuple is associated with the value in the tuple by a property path. When the URI is associated with the value by a property path, the identical-value property path calculation unit 131 sets “identical” as information about the property path and registers the information in the property path calculation table 112.

The different-value property path calculation unit 132 sequentially refers to one of the property paths registered in the property path calculation table 112 and one of the tuples in the tuple table 111 and determines whether a value is associated with the URI in a tuple by a property path. When a value different from the value indicated in the tuple is associated, the different-value property path calculation unit 132 sets “different” as information about the property path and registers the information in the property path calculation table 112.

The coverage rate and match rate calculation unit 133 calculates the rate of the number of property paths registered in the property path calculation table 112 with respect to the number of tuples in the tuple table 111 (the coverage rate), per property path registered in the property path calculation table 112. The coverage rate and match rate calculation unit 133 also calculates the rate of the number of property paths associated with “identical” with respect to the number of property paths registered in the property path calculation table 112 (the match rate), per property path registered in the property path calculation table 112. The coverage rate and match rate calculation unit 133 registers the calculated coverage rate and match rate in the property path candidate table 113. The coverage rate and the match rate calculated by the coverage rate and match rate calculation unit 133 are examples of the evaluation values used for determining whether values associated by a property path are target values that the developer wishes to use. How the coverage rate and the match rate are calculated will be described in detail below.

The notification unit 140 refers to the property path candidate table 113 and detects a property path whose coverage rate and match rate are equal to or more than their respective thresholds. The notification unit 140 notifies the terminal apparatus 200 used by the developer of the detected property path.

The terminal apparatus 200 includes an RDF data utilization unit 210, a transmission unit 220, and an acquisition unit 230.

The RDF data utilization unit 210 performs processing by using the RDF data in the SPARQL endpoint 300. For example, the RDF data utilization unit 210 is a function realized by causing the terminal apparatus 200 to execute application software created by the developer.

The transmission unit 220 transmits tuples, which include values that the RDF data utilization unit 210 has estimated from values in the RDF data, to the property path candidate notification apparatus 100. For example, the transmission unit 220 transmits tuples including values manually inputted by the developer. The transmission unit 220 acquires estimated values from the RDF data utilization unit 210 and transmits tuples including the values.

The acquisition unit 230 acquires a property path from the property path candidate notification apparatus 100. The acquisition unit 230 displays the acquired property path on a monitor, for example.

The SPARQL endpoint 300 includes an RDF data provision unit 310 and an RDF database 320. The RDF data provision unit 310 searches and operates the RDF data in the RDF database 320 in response to a query from the terminal apparatus 200. The RDF database 320 holds the RDF data.

The lines connecting various elements illustrated in FIG. 4 represent only some of the communication paths. Communication paths other than those in FIG. 4 may also be set. For example, the function of each individual element illustrated in FIG. 4 may be realized by causing a computer to execute a program module corresponding to that element.

Hereinafter, the RDF data used in the present embodiment will be described. While the following description is made on specifications of the RDF data used in the disclosure of the present embodiment, the processing according to the present embodiment is also applicable to the RDF data based on other specifications.

Each item of RDF data includes a set (a triple) of a subject, a property, and an object. The subject and the property are each represented by a URI. The object is represented by a URI or a literal. A URI that serves as an object could be the subject of another item of RDF data. For example, a character string or a numerical value is used as a literal that serves as an object. In the present embodiment, only character strings are used as literals, and the term “character string” will be used, instead of the term “literal.”

An individual URI is an identifier represented by “http:// . . . ” and given to an element indicating a thing or a concept. Hereinafter, for simplicity, an individual URI will be abbreviated by using a prefix in Turtle syntax, instead of using “http:// . . . ” More specifically, URIs will be represented as “ex:P101,” “ex:full_name,” etc. In Turtle syntax, for example, a prefix “ex” is actually defined as “@prefix ex: <http://localhost/example/>.”Namely, the URI “ex:P101” is actually “http://localhost/example/P101,” and the URI “ex:full_name” is actually “http://localhost/example/full name.”

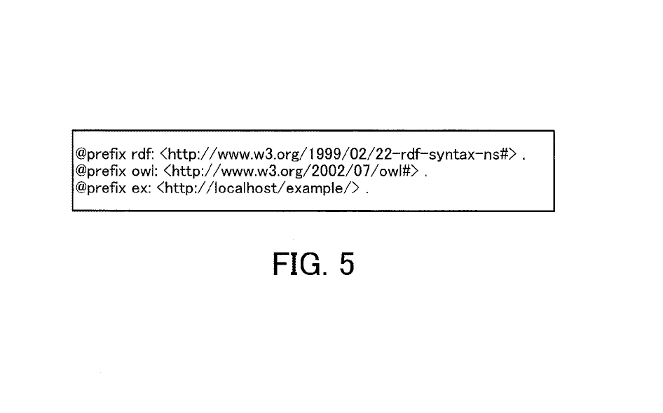

In addition, generally used “rdf:type” (represents a type) and “owl:sameAs” (represents sameness) are also used hereinafter. These prefixes “rdf,” “owl,” and “ex” are defined in FIG. 5.

FIG. 5 illustrates prefix definition examples. By storing the definitions of the actual URIs of the individual prefixes in an apparatus that handles the RDF data as illustrated in FIG. 5, the URIs of the elements included in the RDF data may be abbreviated by using the respective prefixes.

In addition, when the object of a triple serves as the subject of another triple, a blank node without a URI may be used.

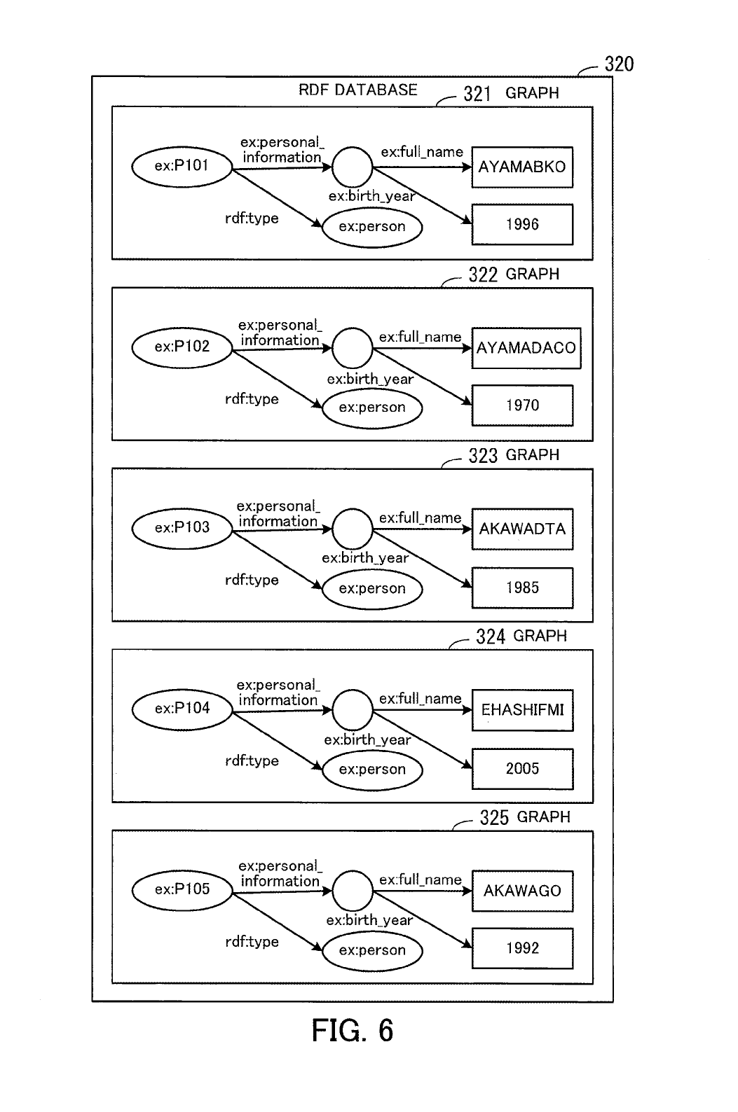

FIG. 6 illustrates examples of RDF data stored in the RDF database. In the example in FIG. 6, the RDF data in the RDF database 320 is represented by graphs 321 to 325. In the graphs 321 to 325, an individual URI as a subject or an object is represented by an oval, a character string as an object is represented by a rectangle, and a blank node without a URI is represented by a circle. In addition, in the graphs 321 to 325, a URI as a property is represented by a line connecting elements such as a circle, an oval, and a character string.

In FIG. 6, while the URIs each represented by “ex:person” in the graphs 321 to 325 are the same URI and are supposed to be represented by a single oval, the URIs are represented by separate ovals to promote better understanding.

In addition, in the example according to the present embodiment, a URI used as a subject or an object in a triple is not used as a property in another triple. In addition, a URI used as a property of a triple is not used as a subject or an object in another triple. However, generally, a URI may be used as any subject, object, or property, and the processing according to the present embodiment is applicable to such general RDF data.

When a URI, a blank node, or a character string is reached from another URI by following a plurality of properties, the plurality of properties is called a property path. A property path is represented by a series of URIs each indicating property, such as “ex:personal_information/ex:full_name.”

In the present embodiment, a URI from which a property path starts will be referred to as the subject of the property path, and another URI, a blank node, or a character string at which the property path ends will be referred to as the object of the property path.

Next, data tables stored in the storage unit 110 in the property path candidate notification apparatus 100 will be described in detail with reference to FIGS. 7 to 9.

FIG. 7 illustrates an example of the tuple table. The tuple table 111 includes columns named “label,” “URI,” and “value.” Under the “label” column, labels each indicating the kind of a tuple are set. Estimated values used by a developer for a certain purpose are given the same label. Under the “URI” column, URIs indicated by the tuples are set. Under the “value” column, values indicated by the tuples are set.

Each of the values set under the “value” column is an estimated value estimated on the basis of a value obtained by following a property path from a subject indicated by a corresponding URI. For example, character strings indicating family names estimated from full names are set under the “value” column of the tuple table 111. While character strings are set under the “value” column in FIG. 7, literals other than character strings or URIs may alternatively be set under the “value” column.

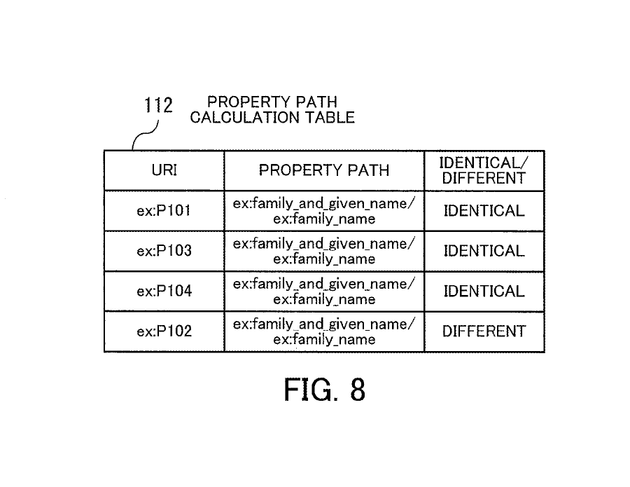

FIG. 8 illustrates an example of the property path calculation table. The property path calculation table 112 includes columns for “URI,” “property path,” and “identical/different.” Under the “URI” column, URIs used as subjects in the RDF data are set. Under the “property path” column, property paths each indicating a path followed from a corresponding URI are set. Under the “identical/different” column, determination results each indicating whether an object value associated with a corresponding URI by a corresponding property path is the same as a value in a corresponding tuple are set. If the same value is set, “identical” is set under the “identical/different” column. If a different value is set, “different” is set under the “identical/different” column.

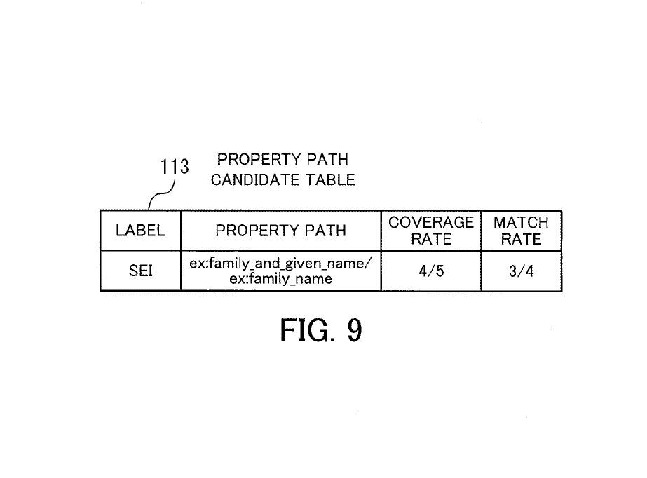

FIG. 9 illustrates an example of the property path candidate table. The property path candidate table 113 includes columns for “label,” “property path,” “coverage rate,” and “match rate.” Under the “label” column, the labels of the tuples whose property path has been evaluated are set. Under the “property path” column, the property path evaluated is set. Under the “coverage rate” column, the coverage rate of the corresponding property path is set. Under the “match rate” column, the match rate of the corresponding property path is set.

The present description assumes that the developer who uses the terminal apparatus 200 in this system develops application software that uses results obtained by performing SPARQL search processing on the SPARQL endpoint 300, for example. For example, the developer develops application software that obtains statistics of birth year values per family name value associated with a URI having “ex:person” as an “rdf:type” value (hereinafter referred to as a “person URI”).

The RDF data in the RDF database 320 illustrated in FIG. 6 do not include any family name values to be used by the application software. In this case, the developer creates a program module (an ad hoc module) for estimating family name values from other values by calculation. In the example in FIG. 6, the developer creates an ad hoc module for estimating the family name values from the full name values. For example, on the basis of the ad hoc module, the terminal apparatus 200 selects a full name, sequentially examines the characters in the full name from the first character, and estimates a character string consisting of the longest characters matching a character string included in a separately prepared family name dictionary from the first character of the full name, to be the family name value of the full name.

However, an estimated value obtained by the ad hoc module could be inaccurate. For example, in the graph 322 in FIG. 6, “AYAMADACO” is set as the full name value. If the family name dictionary includes “AYAMA” and “AYAMADA,” the terminal apparatus 200 estimates “AYAMADA” to be the family name. However, if the actual family name of the corresponding person is “AYAMA” and the given name is “DACO,” the estimated value is incorrect.

While the terminal apparatus 200 executes application software by using the ad hoc module, when accurate values to be used are added to the RDF database 320, the developer usually wishes to replace the ad hoc module by a module using the accurate values. For example, when family name values are added to the RDF database 320, to improve the reliability of the application software, the developer replaces the ad hoc module in the application software by a module using the family name values.

However, in many cases, it is difficult for the developer to know when target values have been added. Namely, an administrator of the SPARQL endpoint 300 does not always notify the developer of such addition appropriately. Even when the developer is notified of such addition, it is difficult for the developer to check the notification each time. Even when there is a mechanism of notifying the developer that some data have been updated, it is not easy to determine whether target values have been added.

Thus, in the second embodiment, the property path candidate notification apparatus 100 evaluates whether values added to the RDF database 320 and associated by the same property path are target values that the developer wishes to use. Only when high evaluation is obtained, the property path candidate notification apparatus 100 notifies the terminal apparatus 200 of the property path leading to the values.

To evaluate a property path, the property path candidate notification apparatus 100 uses values estimated by the developer, (for example, information outputted by the ad hoc module using a family name dictionary). Namely, while most of the values estimated by the developer are probably accurate, some of the estimated values could be inaccurate. Thus, when the probability that a value associated with a URI by a certain property path is the same as a value estimated by the developer for the URI is equal to or more than a threshold, it is determined that an accurate value has been added to a location reached by the property path.

However, when the amount of data added is small, even when accurate values have been added, these values are not able to be used appropriately by the application software. Thus, if notification of a property path is performed each time update processing is performed, the developer is notified excessively while the amount of data added is small. As a result, much burden is placed on the developer. Thus, when the rate of the number of accurate values added with respect to the number of values that the developer wishes to use is equal to or more than a threshold, the property path candidate notification apparatus 100 notifies the developer of a property path leading to the added values.

When notified of a property path candidate, the developer actually visually checks the new data added by him- or herself and determines whether to replace the ad hoc module. In this way, when target values that the developer wishes to use are added, the developer is notified of the addition at appropriate timing and switches the modules appropriately.

Hereinafter, processing performed by the system according to the second embodiment will be described in detail. First, RDF data utilization processing using application software performed by the terminal apparatus 200 will be described.

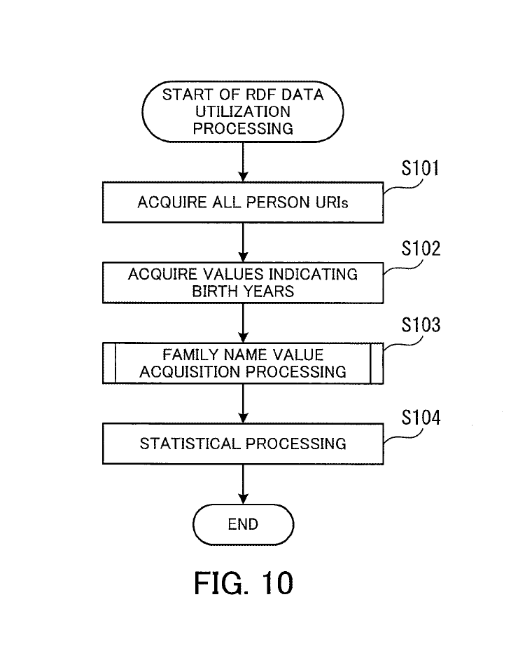

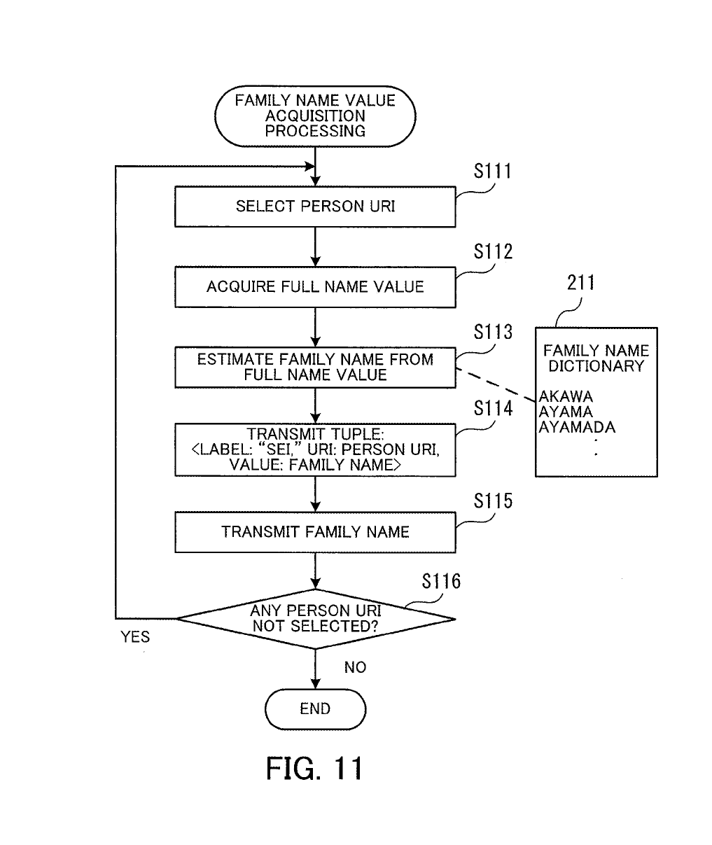

FIG. 10 is a flowchart illustrating an example of a procedure of RDF data utilization processing. The processing illustrated in FIG. 10 will be described step by step.

[Step S101] The RDF data utilization unit 210 acquires all the person URIs from the SPARQL endpoint 300. For example, The RDF data utilization unit 210 transmits a query “SELECT ?n WHERE {?n rdf:type ex:person.}” to the SPARQL endpoint 300. In response to the received query, the RDF data provision unit 310 in the SPARQL endpoint 300 searches for the person URIs. Next, the RDF data provision unit 310 transmits all the person URIs that match the search condition to the terminal apparatus 200.

[Step S102] The RDF data utilization unit 210 acquires values indicating the birth years of the persons corresponding to the acquired person URIs from the SPARQL endpoint 300. For example, the RDF data utilization unit 210 transmits a query for acquiring the birth years from all the “?n” acquired as the search results in step S101. In the case of a person URI “?n=ex:P102,” the query is “SELECT ?y WHERE {ex:P102 ex:personal_information/ex:birth_year ?y.}.” Accordingly, the RDF data provision unit 310 in the SPARQL endpoint 300 transmits the value indicating the birth year in response to the received query.

[Step S103] The RDF data utilization unit 210 invokes an ad hoc module to perform family name value acquisition processing. This processing will be described in detail below with reference to FIG. 11.

[Step S104] The RDF data utilization unit 210 performs statistical processing by using the acquired values (the birth years and the family names) and outputs processing results.

For example, in the statistical processing, the RDF data utilization unit 210 collects the persons whose birth year falls in one of the years from 1980 to 1989, divides the persons into groups according to the birth year, and calculates the top five family names of the persons per year. For example, as the processing results, the calculated five family names per year are organized in table format (not illustrated).

FIG. 11 is a flowchart illustrating an example of a procedure of the family name value acquisition processing. Next, the processing illustrated in FIG. 11 will be described step by step.

[Step S111] The RDF data utilization unit 210 selects one of the unselected person URIs from the person URIs acquired in step S101.

[Step S112] The RDF data utilization unit 210 acquires a value indicating the full name of the person indicated by the selected person URI from the SPARQL endpoint 300. When the selected person URI is “ex:P102,” for example, the RDF data utilization unit 210 transmits a query “SELECT ?n WHERE {ex:P102 ex:personal_information/ex:full_name ?n.}” to the SPARQL endpoint 300. Accordingly, in response to the received query, the RDF data provision unit 310 in the SPARQL endpoint 300 transmits a value indicating the corresponding full name. For example, the RDF data provision unit 310 transmits “?n=“AYAMADABO”” to the RDF data utilization unit 210.

[Step S113] The RDF data utilization unit 210 estimates the corresponding family name from the value indicating the full name. For example, the RDF data utilization unit 210 estimates a character string consisting of the longest characters matching a character string included in a separately prepared family name dictionary from the first character of the full name, to be the family name. In the example in FIG. 11, the family name dictionary 211 includes “AYAMA” and “AYAMADA.” When the full name is “AYAMADABO,” the RDF data utilization unit 210 estimates the longest matching characters, “AYAMADA”, to be the family name.

[Step S114] The transmission unit 220 transmits a tuple including the family name value estimated by the RDF data utilization unit 210 to the property path candidate notification apparatus 100. This tuple includes “SEI” as the label, the selected person URI as the URI, and the estimated family name value as the value.

In the case of the example described in step S113, the tuple transmitted by the transmission unit 220 is represented by “<SEI, ex:P102, AYAMADA>.”

[Step S115] The RDF data utilization unit 210 transmits the family name value to the invoker that has invoked the ad hoc module.

In the case of the example described in step S113, the family name value “AYAMADA” is transmitted to the invoker that has invoked the ad hoc module.

[Step S116] The RDF data utilization unit 210 determines whether there is a person URI that has not been selected yet. If there is such a person URI, the processing returns to step S111. If the RDF data utilization unit 210 has processed all the person URIs, the RDF data utilization unit 210 ends the family name value acquisition processing.

Through the processing illustrated in FIGS. 10 and 11, the terminal apparatus 200 transmits the tuples, which include the values estimated during the RDF data utilization processing using the application software developed by the developer, to the property path candidate notification apparatus 100. The transmitted tuples are received by the reception unit 120 in the property path candidate notification apparatus 100.

When the developer does not use the present embodiment, step S114 is absent in the flowchart in FIG. 11. In this case, step S115 is performed after step S113. Namely, step S114 provides the developer with an advantageous effect according to the present embodiment.

Next, tuple reception processing performed by the reception unit 120 will be described.

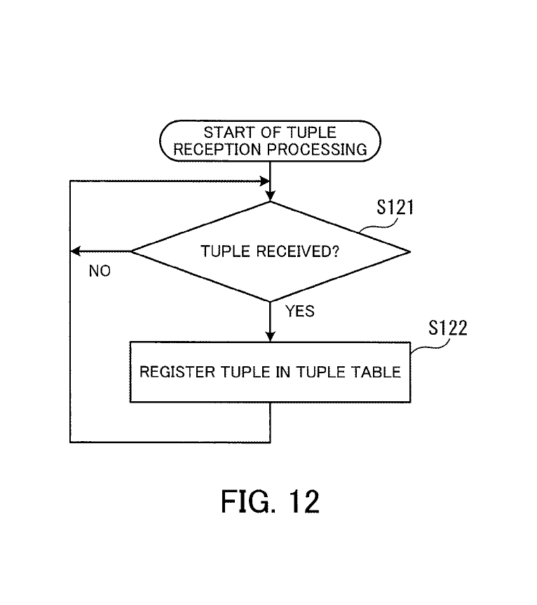

FIG. 12 is a flowchart illustrating an example of a procedure of tuple reception processing. Hereinafter, the processing illustrated in FIG. 12 will be described step by step.

[Step S121] The reception unit 120 determines whether the reception unit 120 has received a tuple from the terminal apparatus 200. If the reception unit 120 has received a tuples, the processing proceeds to step S122. If not, step S121 is repeated.

[Step S122] The reception unit 120 registers the received tuple in the tuple table 111. More specifically, the reception unit 120 registers an individual tuple in which a label, a URI, and a value are associated with each other as a record in the tuple table 111.

The following example assumes that the reception unit 120 has received the following tuples from the terminal apparatus 200 using the RDF data illustrated in FIG. 6.

1st: <SEI, ex: P101, AYAMA>
2nd: <SEI, ex: P102, AYAMADA>
3rd: <SEI, ex: P103, AKAWA>
4th: <SEI, ex: P104, EHASHI>
5th: <SEI, ex: P105, AKAWA>

By causing the reception unit 120 to register these tuples in the tuple table 111, the information illustrated in FIG. 7 is registered in the tuple table 111. The following example assumes that RDF data in the RDF database 320 has been updated subsequently.

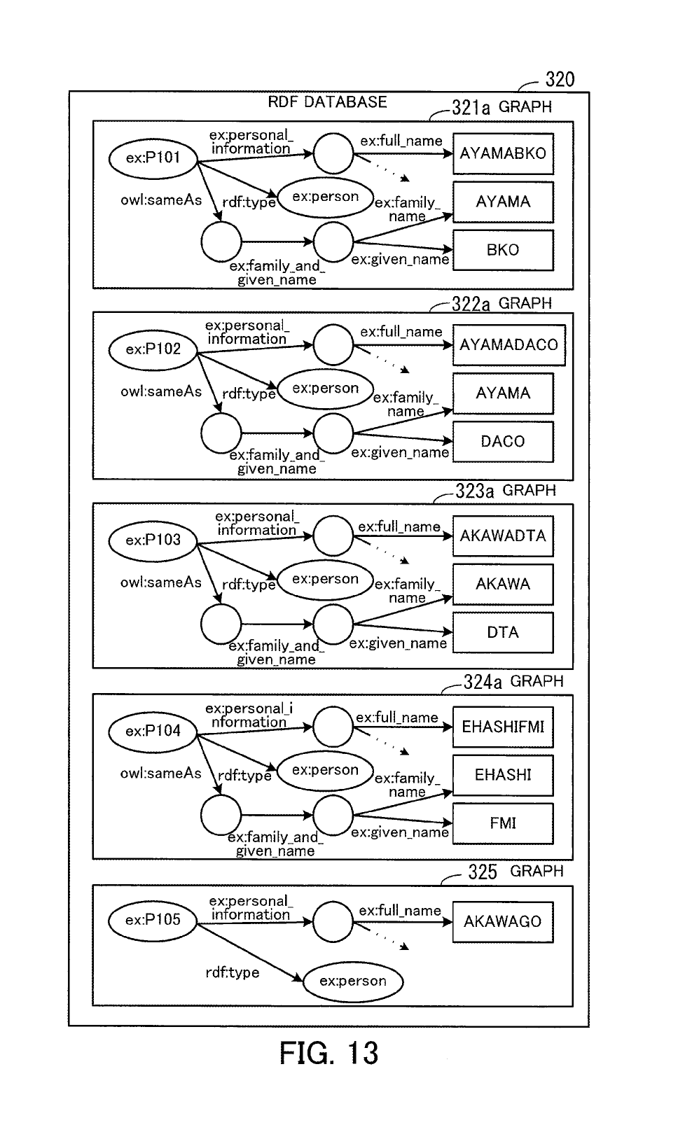

FIG. 13 illustrates a first update example of the RDF data. As illustrated in the example in FIG. 13, the graphs 321 to 324 have been updated to graphs 321a to 324a. More specifically, character strings are newly associated with a property path “ex:family_and_given_name/ex:family_name” and a property path “ex:family_and_given_name/ex:given_name”. The graph 325 has not been updated. When RDF data has been updated, the property path calculation unit 130 in the property path candidate notification apparatus 100 performs property path calculation processing for obtaining a property path to an accurate value corresponding to an estimated value.

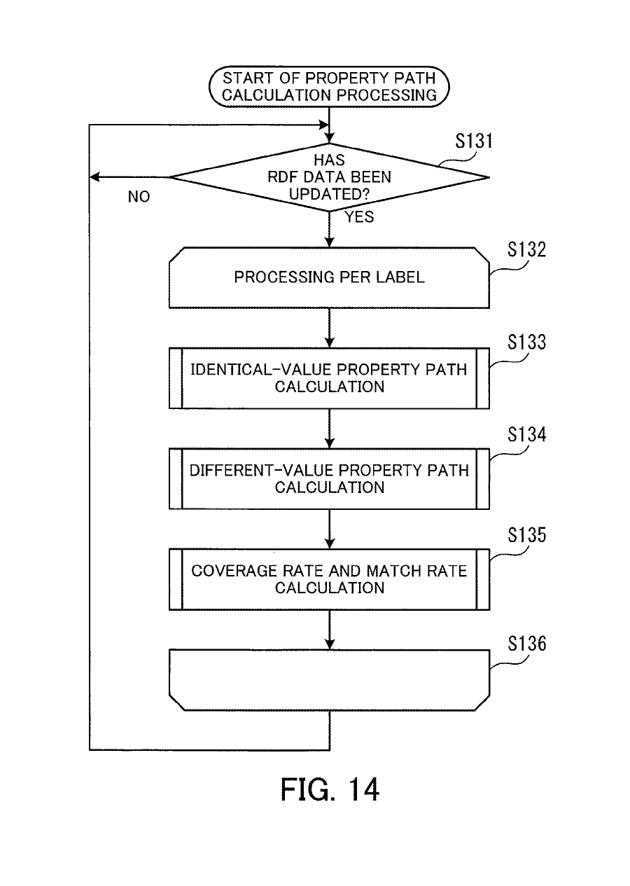

FIG. 14 illustrates an example of a procedure of property path calculation processing. Hereinafter, the processing illustrated in FIG. 14 will be described step by step.

[Step S131] The property path calculation unit 130 determines whether RDF data has been updated. For example, the property path calculation unit 130 regularly checks the RDF database 320 in the SPARQL endpoint 300 to determine whether any RDF data has been updated. Any of various methods may be used to determine whether any RDF data has been updated. For example, the property path calculation unit 130 may transmit a query “SELECT COUNT(*) WHERE {?s ?p ?o.}” to the RDF data provision unit 310, acquire the total number of triples stored in the RDF database 320, and store the total number of triples in a table not illustrated. In this case, each time the property path calculation unit 130 acquires the total number of triples, the property path calculation unit 130 compares the current total number of triples with the previous total number of triples. Alternatively, when the RDF data provision unit 310 in the SPARQL endpoint 300 updates RDF data, the RDF data provision unit 310 may notify the property path calculation unit 130 of the update. In this case, when notified by the RDF data provision unit 310 that the RDF data has been updated, the property path calculation unit 130 determines that the RDF data has been updated. If the RDF data has been updated, the processing proceeds to step S132. If not, step S131 is repeated.

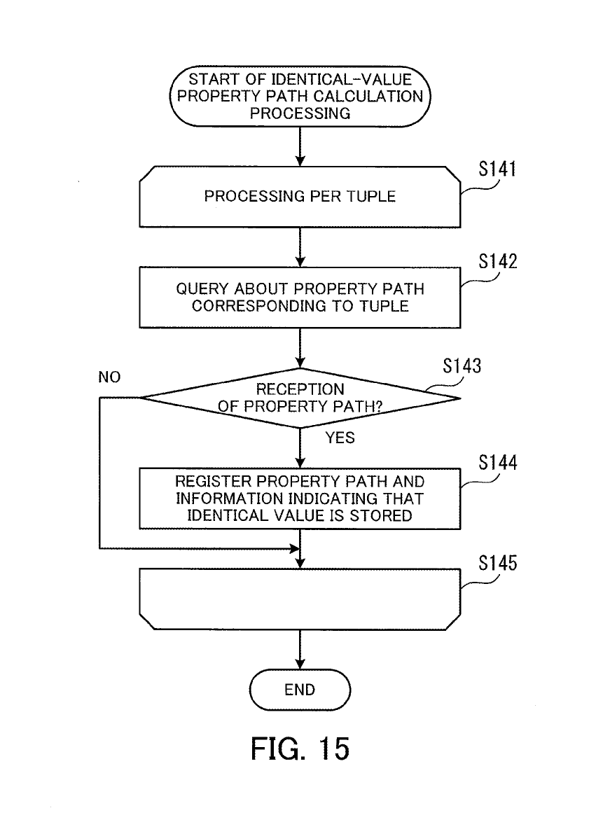

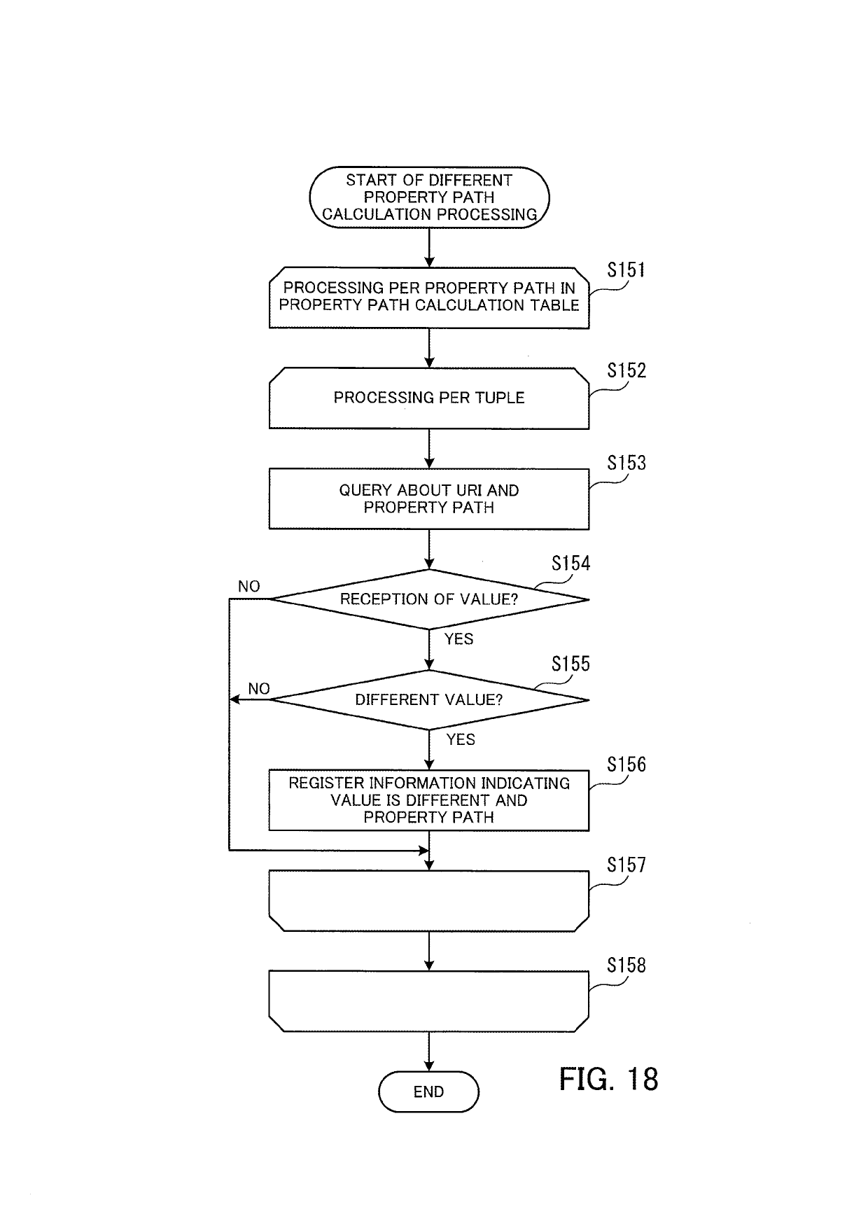

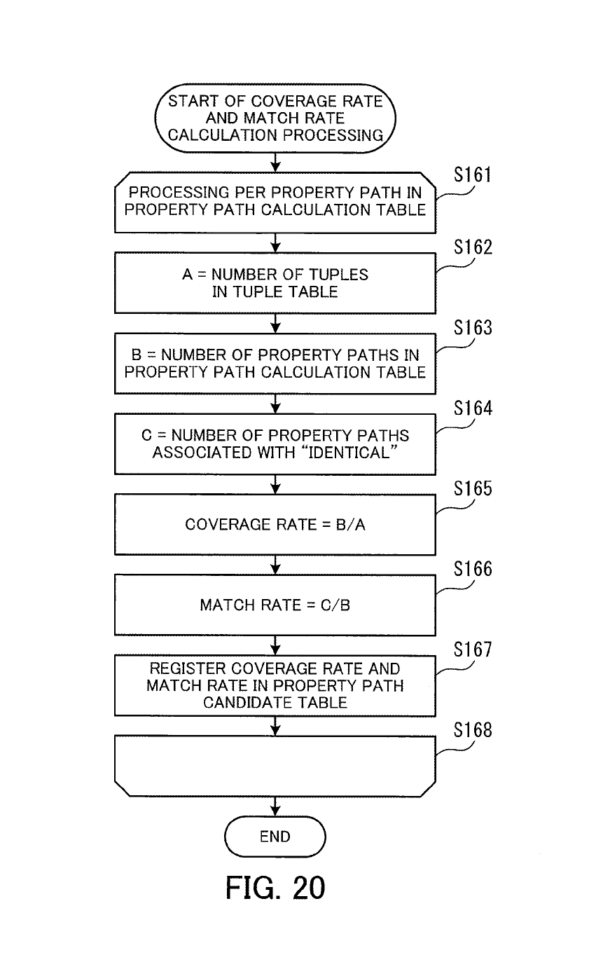

The property path calculation unit 130 may perform processing in step S132 and subsequent steps regularly, e.g., every 30 minutes, instead of determining whether RDF data has been updated in step S131.

[Step S132] The property path calculation unit 130 performs processing in steps S133 to S135 per label set in the tuple table 111. In the example in FIG. 7, “SEI” is only the label registered in the tuple table 111.

[Step S133] The property path calculation unit 130 causes the identical-value property path calculation unit 131 to perform identical-value property path calculation processing, which will be described in detail below with reference to FIG. 15.

[Step S134] The property path calculation unit 130 causes the different-value property path calculation unit 132 to perform different-value property path calculation processing, which will be described in detail below with reference to FIG. 18.

[Step S135] The property path calculation unit 130 causes the coverage rate and match rate calculation unit 133 to perform coverage rate and match rate calculation processing, which will be described in detail below with reference to FIG. 20.

[Step S136] After the property path calculation unit 130 processes all the labels, the processing returns to step S131.

Next, the identical-value property path calculation processing will be described in detail.

FIG. 15 illustrates an example of a procedure of the identical-value property path calculation processing. Hereinafter, the processing illustrated in FIG. 15 will be described step by step.

[Step S141] The identical-value property path calculation unit 131 performs processing in steps S142 to S144 per tuple registered in the tuple table 111.

[Step S142] The identical-value property path calculation unit 131 queries the SPARQL endpoint 300 about a property path corresponding to the processing target tuple. For example, the identical-value property path calculation unit 131 transmits a query to the SPARQL endpoint 300, the query being about the presence of a property path leading to the same character string as the value associated with the URI indicated in the tuple.

The RDF data provision unit 310 in the SPARQL endpoint 300 according to the present embodiment has a function of receiving the query about the presence of a property path leading to a specified URI or character string from a specified URI and transmitting a result.

For example, when the RDF data provision unit 310 receives a query about the presence of a property path from “ex:P101” to the value “AYAMA,” on the basis of a SPARQL query “SELECT ?p1 {ex:P101 ?p1 “AYAMA”.},” the RDF data provision unit 310 searches for a property path having a length of 1 (a result obtained with ?p1). Next, on the basis of a SPARQL query “SELECT ?p1 ?p2 {ex:P101 ?p1 ?o1. ?o1 ?p2 “AYAMA”. },” the RDF data provision unit 310 searches for a property path having a length of 2 (a combination of results obtained with ?p2 and ?p2). Next, on the basis of a SPARQL query “SELECT ?p1 ?p2 ?p3 {ex:P101 ?p1 ?o1. ?o1 ?p2 ?o2. ?o2 ?p3 “AYAMA”. },” the RDF data provision unit 310 searches for a property path having a length of 3 (a combination of results obtained with ?p1, ?p2, and ?p3). In this way, the RDF data provision unit 310 begins with a property path having a length of 1 and performs search processing while increasing the length of the property path (the number of properties followed) one by one. The RDF data provision unit 310 performs search processing based on a corresponding SPARQL query to each length and transmits one or more property paths obtained as a result of the search processing. In this case, the RDF data provision unit 310 appropriately sets a condition to end the search processing. For example, the RDF data provision unit 310 may set an upper limit value to the length of the property path. When the RDF data provision unit 310 cannot find any property path as a result of the search processing, the RDF data provision unit 310 transmits a notification indicating that there is no matching property path.

When a URI or a property needs to be excluded on a property path, the identical-value property path calculation unit 131 may query the RDF data provision unit 310 about a property path by appropriately using a FILTER phrase so that such a URI or a property is excluded.

A property path may be followed not only from a subject to an object but also from an object to a subject.

When a property path is followed from an object to a subject, a limitation may be added by appropriately using a FILTER phrase so that a property path is not looped.

The following examples assume that no upper limit is set to the length of the property path and that the search direction is always from a subject to an object.

[Step S143] The identical-value property path calculation unit 131 determines whether the identical-value property path calculation unit 131 has received one or more property paths as a response. If the identical-value property path calculation unit 131 has received one or more property paths as a response, the processing proceeds to step S144. If not, the processing proceeds to step S145.

[Step S144] The identical-value property path calculation unit 131 registers the URI indicated in the processing target tuple, the received property path, and information indicating that the identical value is stored in the property path calculation table 112. This registration is performed per property path.

[Step S145] When the identical-value property path calculation unit 131 processes all the tuples, the identical-value property path calculation unit 131 ends the identical-value property path calculation processing.

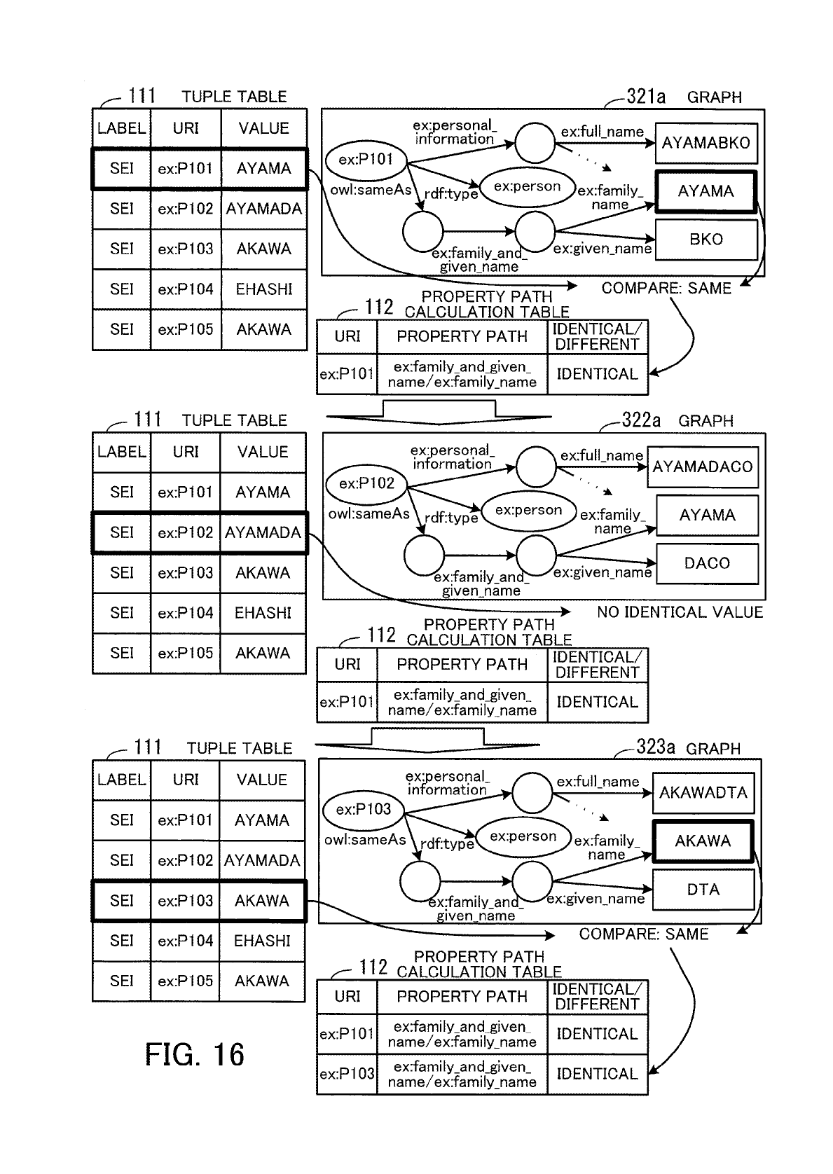

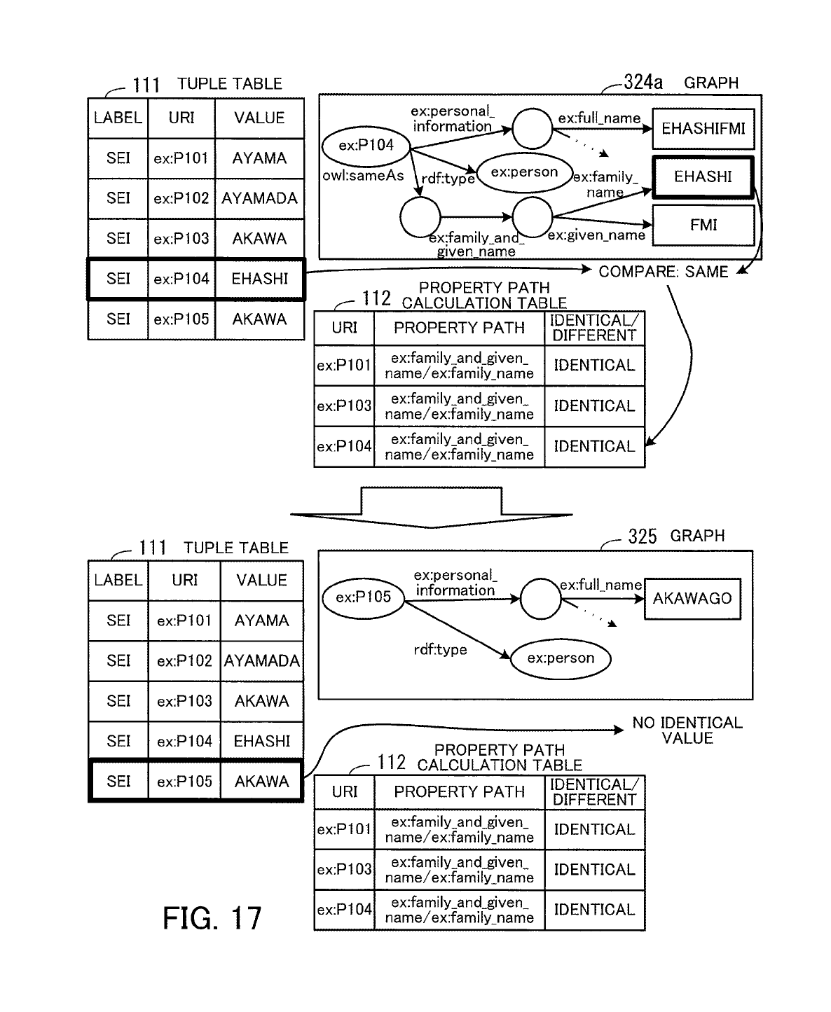

In this way, a property path leading to the same character string as a value indicated in a tuple is registered in the property path calculation table 112. Hereinafter, a specific example of the identical-value property path calculation will be described with reference to FIGS. 16 and 17,

FIGS. 16 and 17 illustrate an identical-value property path calculation example. First, the identical-value property path calculation unit 131 performs identical-value property path calculation processing on the first tuple in the tuple table 111. In the first tuple, the URI is “ex:P101” and the value is “AYAMA.” On the basis of this tuple, the identical-value property path calculation unit 131 transmits a query about a property path. In response, the RDF data provision unit 310 searches for the same character string as the corresponding value “AYAMA,” starting from the URI “ex:P101” in the graph 321a. Since the RDF data in the graph 321a includes the same character string as the value “AYAMA,” the RDF data provision unit 310 transmits a property path “ex:family and given name/ex:family name” leading to the character string. Next, the identical-value property path calculation unit 131 registers the URI “ex:P101” indicated in the tuple, the acquired property path “ex:family and given name/ex:family name,” and information “identical” indicating that the same value is stored in the graphs 321a in the property path calculation table 112 as a single record.

Next, the identical-value property path calculation unit 131 performs identical-value property path calculation processing on the second tuple in the tuple table 111. In the second tuple, the URI is “ex:P102” and the value is “AYAMADA.” On the basis of this tuple, the identical-value property path calculation unit 131 transmits a query about a property path. In response, the RDF data provision unit 310 searches for the same character string as the corresponding value “AYAMADA,” starting from the URI “ex:P102” in the graph 322a. Since the RDF data in the graph 322a does not include the same character string as the value “AYAMADA,” the RDF data provision unit 310 transmits a notification indicating that there is no matching property path. In this case, the identical-value property path calculation unit 131 does not register any record in the property path calculation table 112.

Next, the identical-value property path calculation unit 131 performs identical-value property path calculation processing on the third tuple in the tuple table 111. In the third tuple, the URI is “ex:P103” and the value is “AKAWA.” On the basis of this tuple, the identical-value property path calculation unit 131 transmits a query about a property path. In response, the RDF data provision unit 310 searches for the same character string as the corresponding value “AKAWA,” starting from the URI “ex:P103” in the graph 323a. Since the RDF data in the graph 323a includes the same character string as the value “AKAWA,” the RDF data provision unit 310 transmits a property path “ex:family_and_given_name/ex:family_name” leading to the character string. Next, the identical-value property path calculation unit 131 registers the URI “ex:P103” indicated in the tuple, the acquired property path “ex:family_and_given_name/ex:family_name,” and information “identical” indicating that the same value is stored in the graphs 323a in the property path calculation table 112 as a single record.

Next, the identical-value property path calculation unit 131 performs identical-value property path calculation processing on the fourth tuple in the tuple table 111. In the fourth tuple, the URI is “ex:P104” and the value is “EHASHI.” On the basis of this tuple, the identical-value property path calculation unit 131 transmits a query about a property path. In response, the RDF data provision unit 310 searches for the same character string as the corresponding value “EHASHI,” starting from the URI “ex:P104” in the graph 324a. Since the RDF data in the graph 324a includes the same character string as the value “EHASHI,” the RDF data provision unit 310 transmits a property path “ex:family_and_given_name/ex:family_name” leading to the character string. Next, the identical-value property path calculation unit 131 registers the URI “ex:P104” indicated in the tuple, the acquired property path “ex:family_and_given_name/ex:family_name,” and information “identical” indicating that the same value is stored in the graphs 324a in the property path calculation table 112 as a single record.

Finally, the identical-value property path calculation unit 131 performs identical-value property path calculation processing on the fifth tuple in the tuple table 111. In the fifth tuple, the URI is “ex:P105” and the value is “AKAWA.” On the basis of this tuple, the identical-value property path calculation unit 131 transmits a query about a property path. In response, the RDF data provision unit 310 searches for the same character string as the corresponding value “AKAWA,” starting from the URI “ex:P105” in the graph 325. Since the RDF data in the graph 325 does not include the same character string as the value “AKAWA,” the RDF data provision unit 310 transmits a notification indicating that there is no matching property path. In this case, the identical-value property path calculation unit 131 does not register any record in the property path calculation table 112.

The example in FIGS. 16 and 17 assumes that the SPARQL endpoint 300 has a function of handling equivalent URIs expressed by “owl:sameAs” without distinction. Therefore, “ex:family_and_given name/ex:family_name” is followed from “ex:P102.” When equivalent URIs expressed by “owl:sameAs” are not distinguishable, “owl:sameAs/ex:family_and_given_name/ex:family_name” is a property path to be transmitted as a response.

After the identical-value property path calculation unit 131 performs the identical-value property path calculation processing in this way, the different-value property path calculation unit 132 performs different-value property path calculation processing.

FIG. 18 is a flowchart illustrating an example of a procedure of different-value property path calculation processing. Hereinafter, the processing illustrated in FIG. 18 will be described step by step.

[Step S151] The different-value property path calculation unit 132 performs processing in steps S152 to S157 per unique property path registered in the property path calculation table 112. In the example illustrated in FIG. 17, “ex:family_and_given_name/ex:family_name” is the only property path registered in the property path calculation table 112.

[Step S152] The different-value property path calculation unit 132 performs processing in steps S153 to S156 per tuple registered in the tuple table 111.

[Step S153] The different-value property path calculation unit 132 queries the SPARQL endpoint 300 about a value associated with a URI indicated in a processing target tuple associated by a processing target property path. If there is a value associated with the URI, the RDF data provision unit 310 in the SPARQL endpoint 300 transmits the value as a response. Otherwise, the RDF data provision unit 310 transmits a notification indicating that there is no value.

[Step S154] The different-value property path calculation unit 132 determines whether the different-value property path calculation unit 132 has received a value. If the different-value property path calculation unit 132 has received a value, the processing proceeds to step S155. If not, the processing proceeds to step S157.

[Step S155] The different-value property path calculation unit 132 determines whether the value is the same as the value in the processing target tuple. If so, the processing proceeds to step S157. If not, the processing proceeds to step S156.

[Step S156] The different-value property path calculation unit 132 registers information indicating that the value is different from the value in the processing target tuple, the URI indicated in the processing target tuple, and the processing target property path in the property path calculation table 112.

[Step S157] When the different-value property path calculation unit 132 processes all the tuples, the processing proceeds to step S158.

[Step S158] When the different-value property path calculation unit 132 has processed all the property paths, the different-value property path calculation unit 132 ends the different-value property path calculation processing.

In this way, a URI associated with a different value from that indicated in the tuple by the property path registered in the property path calculation table 112 is registered in the property path calculation table 112.

The determination of whether a value associated with a URI indicated in a processing target tuple by a processing target property path is the same as a value in the processing target tuple may be made in another way. For example, the determination may be made by referring to the property path calculation table 112 and determining whether the information under the “identical/different” column corresponding to a URI indicated in a processing target tuple is “identical.”

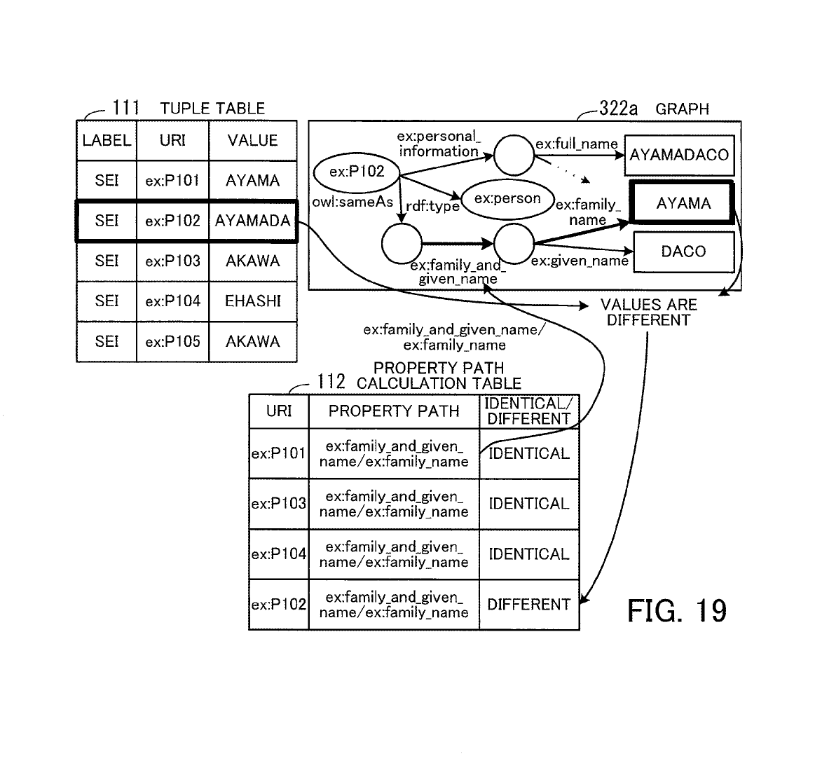

FIG. 19 illustrates a different-value property path calculation example. Of all the tuples registered in the tuple table 111, those tuples whose corresponding records have already been registered in the property path calculation table 112 by the identical-value property path calculation processing are determined to be “NO” in step S155 by the different-value property path calculation processing. As a result, for those tuples, new records are not registered in the property path calculation table 112 by the different-value property path calculation processing.

In addition, for the second and fifth tuples (the URIs “ex:P102” and “ex:P105”) in the tuple table 111, records are not registered in the property path calculation table 112 by the identical-value property path calculation processing.

When the different-value property path calculation processing is performed on the second tuple in the tuple table 111, the different-value property path calculation unit 132 transmits a query about a value. In response to the query, the RDF data provision unit 310 transmits information including a value, namely, a character string “AYAMA,” associated with the URI “ex:P102” in the graph 322a by the property path “ex:family_and_given_name/ex:family_name.” When receiving the response, the different-value property path calculation unit 132 determines that the value “AYAMADA” in the processing target tuple and the received value “AYAMA” are different. Next, the different-value property path calculation unit 132 registers the URI “ex:P102” indicated in the tuple, the received property path “ex:family_and_given_name/ex:family_name,” and information “different” indicating that the values are different in the property path calculation table 112 as a single record.

When the different-value property path calculation processing is performed on the fifth tuple in the tuple table 111, the different-value property path calculation unit 132 determines that there is no value associated with the URI “ex:P105” by the property path “ex:family_and_given_name/ex:family_name” in the graph 325. Thus, the different-value property path calculation unit 132 does not register any value in the property path calculation table 112.

When the different-value property path calculation unit 132 ends the different-value property path calculation processing, the coverage rate and match rate calculation processing is performed.

FIG. 20 is a flowchart illustrating an example of a procedure of the coverage rate and match rate calculation processing. Hereinafter, the processing illustrated in FIG. 20 will be described step by step.

[Step S161] The coverage rate and match rate calculation unit 133 performs processing in steps S162 to S167 per unique property path registered in the property path calculation table 112. In the example illustrated in FIG. 19, “ex:family_and_given_name/ex:family_name” is the only property path registered in the property path calculation table 112.

[Step S162] The coverage rate and match rate calculation unit 133 sets the number of processing target tuples in the tuple table 111 to a variable A.

[Step S163] The coverage rate and match rate calculation unit 133 sets the number of records (the number of property paths in the property path calculation table 112) including processing target property paths set in the property path calculation table to a variable B.

[Step S164] Of all the processing target property paths in the property path calculation table, the coverage rate and match rate calculation unit 133 sets the number of property paths associated with “identical” under the “identical/different” column to a variable C.

[Step S165] The coverage rate and match rate calculation unit 133 sets a result obtained by dividing the variable B by the variable A (B/A) to the coverage rate.

[Step S166] The coverage rate and match rate calculation unit 133 sets a result obtained by dividing the variable C by the variable B (C/B) to the match rate.

[Step S167] The coverage rate and match rate calculation unit 133 registers the calculated coverage rate and match rate in the property path candidate table 113.

[Step S168] When the coverage rate and match rate calculation unit 133 has processed all the property paths, the coverage rate and match rate calculation unit 133 ends the coverage rate and match rate calculation processing.

In this way, the coverage rate and match rate calculation unit 133 calculates the coverage rate and the match rate.

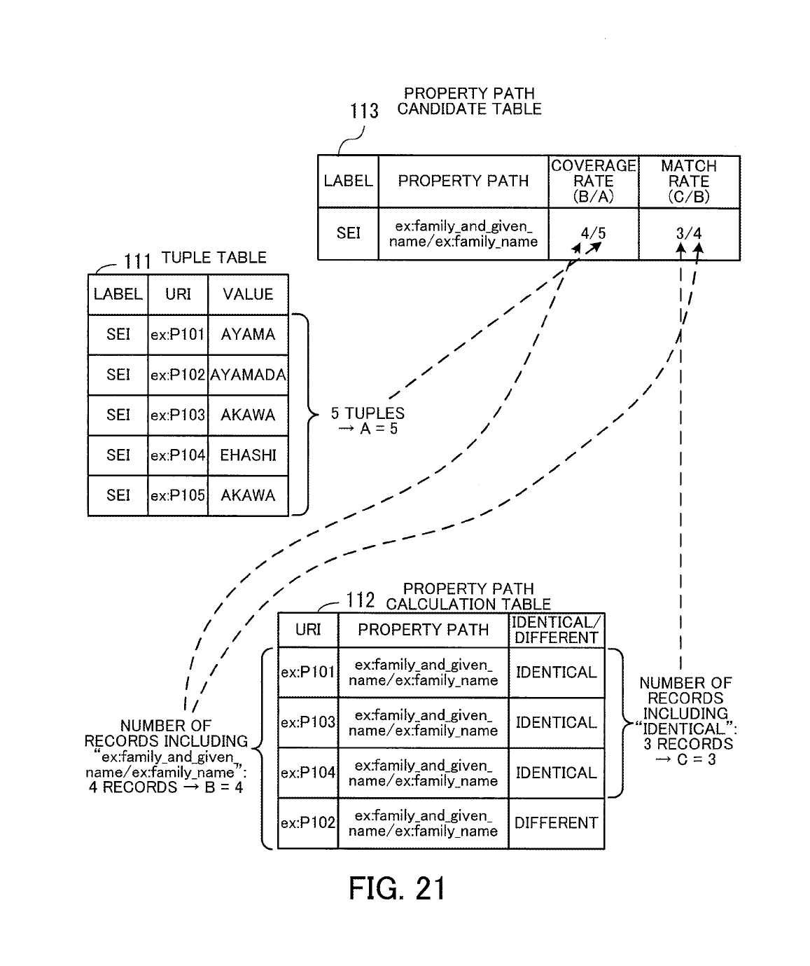

FIG. 21 illustrates a coverage rate and match rate calculation example. In the example in FIG. 21, since five tuples are registered in the tuple table 111, A=5. In addition, since four property paths each being “ex:family_and_given_name/ex:family_name” are registered in the property path calculation table 112, B=4. In addition, since three of the property paths “ex:family_and_given_name/ex:family_name” registered in the property path calculation table 112 are associated with “identical” under the “identical/different” column, C=3. As a result, the coverage rate is 4/5, and the match rate is 3/4.

Hereinafter, statistical meanings represented by the coverage rate and the match rate will be described. The match rate is the rate of concordance (concordance rate) between estimated values of a plurality of entities (persons or things), respectively, and values associated with the plurality of entities by specified relation information, respectively. The coverage rate is the rate of existence (existence rate) of entities having values associated by the relation information, among the plurality of entities. The coverage rate and the match rate will be described in detail below.

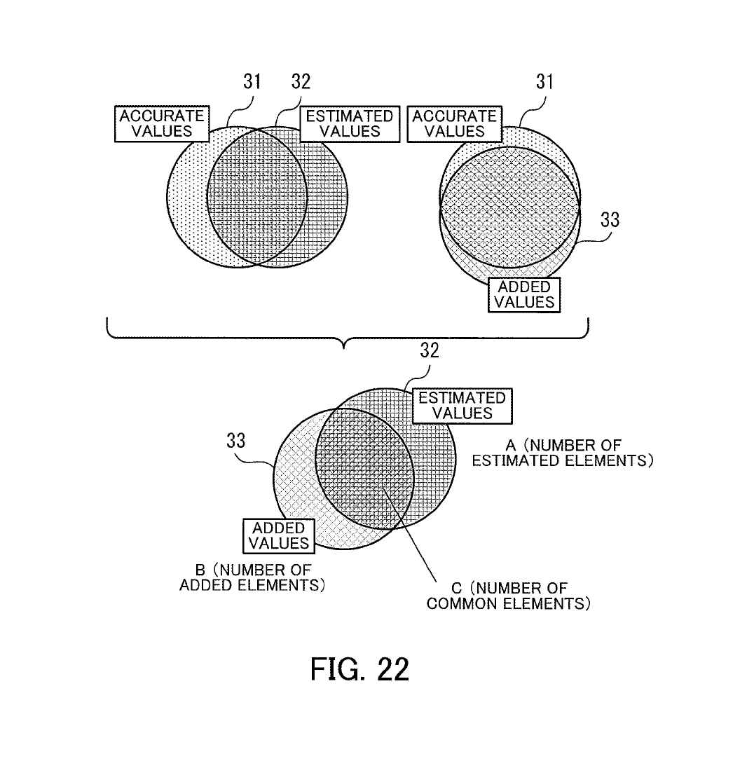

FIG. 22 conceptually illustrates the coverage rate and the match rate. When values (a group of accurate values 31) to be used for application software created by the developer are not acquired from the RDF data, the developer creates an ad hoc module for estimating values to be used. The terminal apparatus 200 uses the ad hoc module to estimate values to be used. While a group of estimated values 32 and the group of accurate values 31 mostly overlap with each other, they are partly different. Namely, while most of the results of the estimation performed by the developer (the results outputted by the ad hoc module using a family name dictionary) are accurate, some of the results could be inaccurate. It is fair to say that values added to the RDF database 320 used to be provided publicly (a group of added values 33) are probably more accurate than estimated values.

The coverage rate is a value of the rate (B/A) of the number of elements in the group of added values 33 with respect to the number of elements in the group of estimated values 32. Namely, the coverage rate indicates the rate at which the values used for application software created by the developer are acquired from the RDF data. Unless the coverage rate is high, it is meaningless to replace the ad hoc module in the application software by a module for acquiring values from the RDF data. Thus, only when the coverage rate is equal to or more than a certain threshold, the notification unit 140 notifies the terminal apparatus 200 of the corresponding property path.

The match rate is a value of the rate (C/B) of the number of elements common in the group of estimated values 32 and the group of added values 33 with respect to the number of elements in the group of added values 33. Namely, the match rate indicates the rate at which the values estimated by the developer match the available values. Thus, it is important that the match rate be high. Since some of the values estimated by the ad hoc module created by the developer could be inaccurate, it is important that the values that the developer wishes to replace have a match rate equal to or more than a certain threshold. Thus, only when the match rate is equal to or more than a certain threshold, the notification unit 140 notifies the terminal apparatus 200 of the corresponding property path.

Namely, only when both the coverage rate and the match rate exceed their respective thresholds, the notification unit 140 notifies the terminal apparatus 200 of the corresponding property path. In this way, excessive notification is prevented.

Next, notification processing of the notification unit 140 will be described in detail.

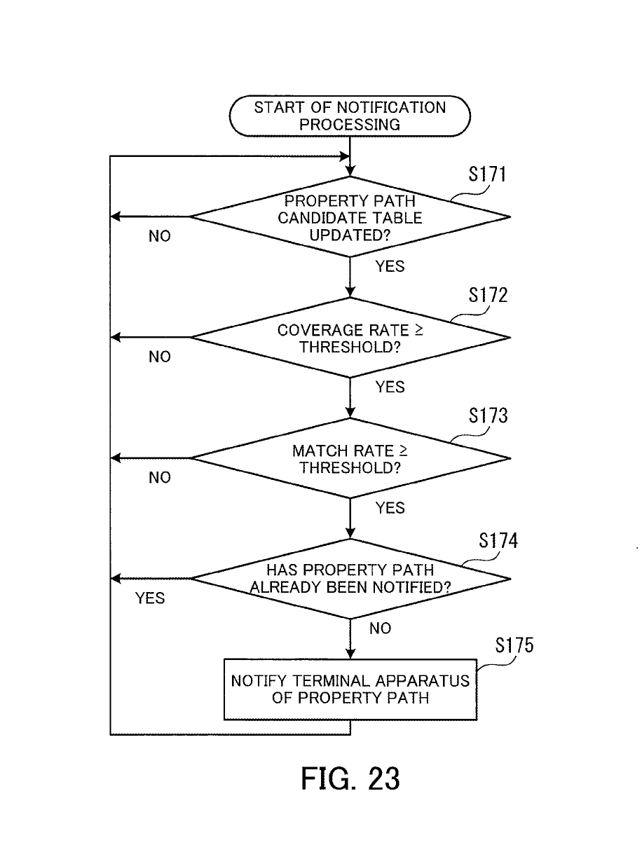

FIG. 23 illustrates an example of a procedure of notification processing. Hereinafter, the processing illustrated in FIG. 23 will be described step by step.

[Step S171] The notification unit 140 monitors whether the property path candidate table 113 has been updated. If the property path candidate table 113 has been updated, the processing proceeds to step S172. If not, the processing in step S171 is repeated.

[Step S172] The notification unit 140 determines whether the coverage rate in the record updated in the property path candidate table 113 is equal to or more than a threshold. If the coverage rate is equal to or more than a threshold, the processing proceeds to step S173. If not, the processing returns to step S171.

[Step S173] The notification unit 140 determines whether the match rate in the record updated in the property path candidate table 113 is equal to or more than a threshold. If the match rate is equal to or more than a threshold, the processing proceeds to step S174. If not, the processing returns to step S171.

[Step S174] The notification unit 140 determines whether the terminal apparatus 200 has already been notified of the property path in the record updated in the property path candidate table 113. For example, the notification unit 140 holds a history of property paths of which the terminal apparatus 200 has already been notified. If the target property path is already registered in the history, the notification unit 140 determines that the terminal apparatus 200 has already been notified of the property path. If the terminal apparatus 200 has already been notified of the property path, the processing returns to step S171. If not, the processing proceeds to step S175.

[Step S175] The notification unit 140 notifies the terminal apparatus 200 of the property path in the record updated in the property path candidate table 113.

In this step, the notification unit 140 may notify the terminal apparatus 200 of the coverage rate and the match rate, along with the property path. After the notification of the property path, the processing returns to step S171.

In this way, when both the coverage rate and the match rate are equal to or more than their respective thresholds, the notification unit 140 notifies the terminal apparatus 200 of the property path. The following description assumes an example in which the values associated by the property path “ex:family_and_given_name/ex:family_name” as illustrated in FIG. 13 are added to the graphs in the RDF database 320 in FIG. 6 sequentially from the top graph 321 over time. In this case, when at least a certain number of values, which are the same as those in the tuples, are added, the notification unit 140 notifies the terminal apparatus 200 of the property path “ex:family_and_given_name/ex:family_name.”

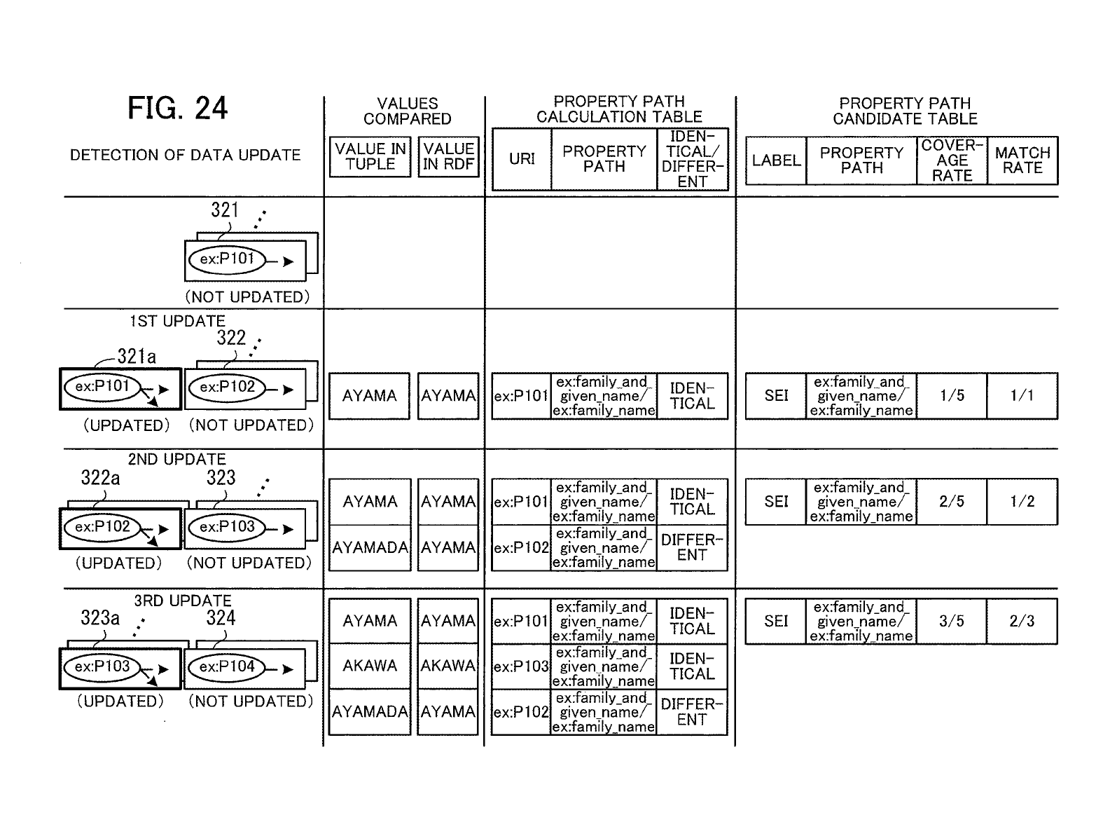

The following describes the coverage rate and the match rate that are calculated each time a value is added in a graph and also describes how the notification unit 140 determines whether to make a notification of the property path each time a value is added in a graph, with reference to FIGS. 24 to 26.

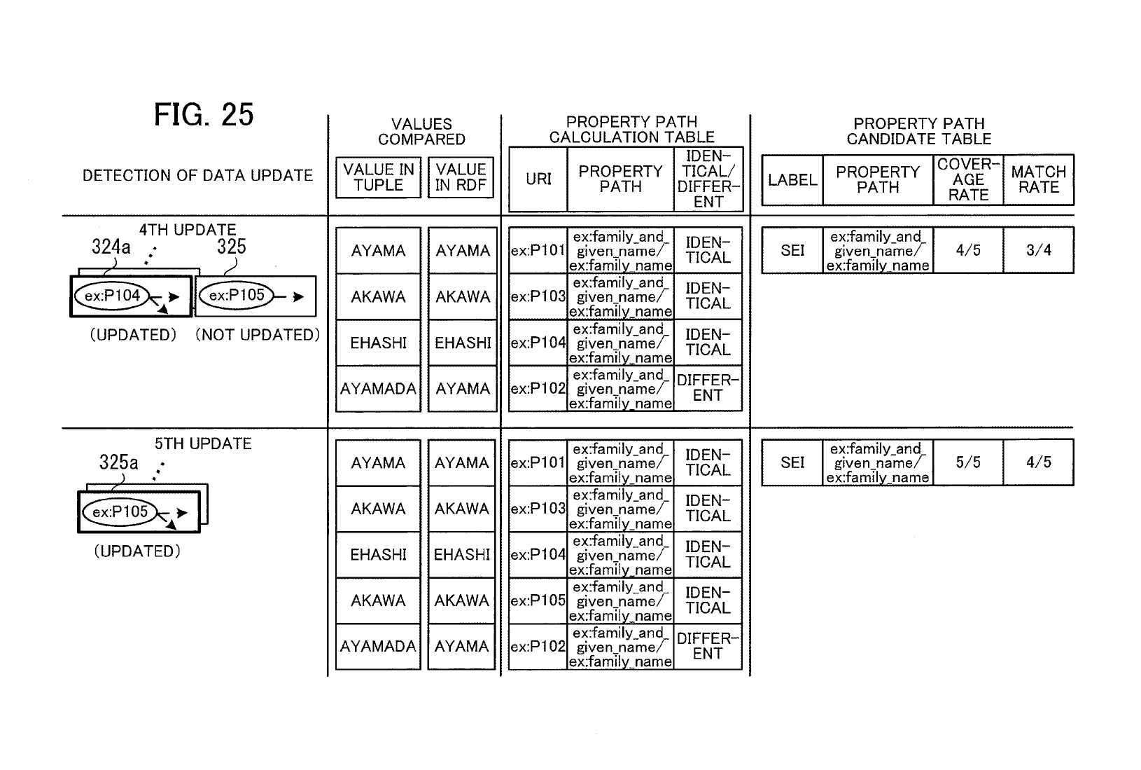

FIGS. 24 and 25 illustrate coverage rate and match rate calculation results per data update. FIG. 24 illustrates update results from first to third data updates.

In the first data update, the same value as that in the tuple in the graph 321 is newly associated by the property path “ex:family_and_given_name/ex:family_name,” and the graph 321 is updated to the graph 321a. After the first data update, the coverage rate is 1/5, and the match rate 1/1.

In the second data update, a value different from that in the tuple in the graph 322 is newly associated by the property path “ex:family_and_given_name/ex:family_name,” and the graph 322 is updated to the graph 322a. After the second data update, the coverage rate is 2/5, and the match rate 1/2.

In the third data update, the same value as that in the tuple in the graph 323 is newly associated by the property path “ex:family_and_given_name/ex:family_name,” and the graph 323 is updated to the graph 323a. After the third data update, the coverage rate is 3/5, and the match rate 2/3.

FIG. 25 illustrates update results from fourth and fifth data updates.

In the fourth data update, the same value as that in the tuple in the graph 324 is newly associated by the property path “ex:family_and_given_name/ex:family_name,” and the graph 324 is updated to the graph 324a. After the fourth data update, the coverage rate is 4/5, and the match rate 3/4.

In the fifth data update, the same value as that in the tuple in the graph 325 is newly associated by the property path “ex:family_and_given_name/ex:family_name,” and the graph 325 is updated to the graph 325a. After the fifth data update, the coverage rate is 5/5, and the match rate 4/5.

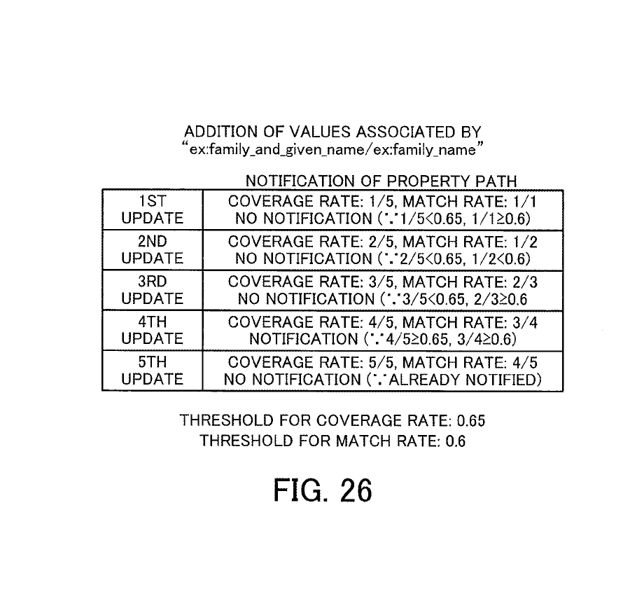

FIG. 26 illustrates a property path notification determination example. The example in FIG. 26 assumes that the threshold for the coverage rate is 0.65 and the threshold for the match rate is 0.6.

After the first data update illustrated in FIG. 24, while the match rate is more than its threshold, the coverage rate is less than its threshold. Thus, the notification unit 140 determines not to notify the terminal apparatus 200 of the property path. After the second data update illustrated in FIG. 24, both the coverage rate and the match rate are less than their respective thresholds. Thus, the notification unit 140 determines not to notify the terminal apparatus 200 of the property path. After the third data update illustrated in FIG. 24, while the match rate is more than its threshold, the coverage rate is less than its threshold. Thus, the notification unit 140 determines not to notify the terminal apparatus 200 of the property path.

After the fourth data update illustrated in FIG. 25, both the coverage rate and the match rate are more than their respective thresholds. Thus, the notification unit 140 determines to notify the terminal apparatus 200 of the property path. After the fifth data update illustrated in FIG. 25, while both the coverage rate and the match rate are more than their respective thresholds, the notification unit 140 has already notified the terminal apparatus 200 of the property path. Thus, the notification unit 140 determines not to notify the terminal apparatus 200 of the property path.

In this way, when there is a sufficient amount of data, the developer is notified of addition of target values, which the developer wishes to use, in the RDF data. FIGS. 24 to 26 illustrate an example in which the RDF data in the RDF database 320 is updated as illustrated in FIG. 13. In this example, both of the coverage rate and the match rate finally exceed their respective thresholds. However, there are cases in which the match rate remains below its threshold while the coverage rate is brought to be equal to or more than its threshold, depending on the update content of the RDF data.

To reduce the processing load, the tuples including the processing target labels in the tuple table may be deleted after the terminal apparatus 200 is notified of the property path. In the case of the example in FIGS. 24 to 26, after the terminal apparatus 200 is notified of the property path as a result of the fourth data update, the five tuples including the label “SEI” in the tuple table 111 illustrated in FIG. 7 may be deleted.

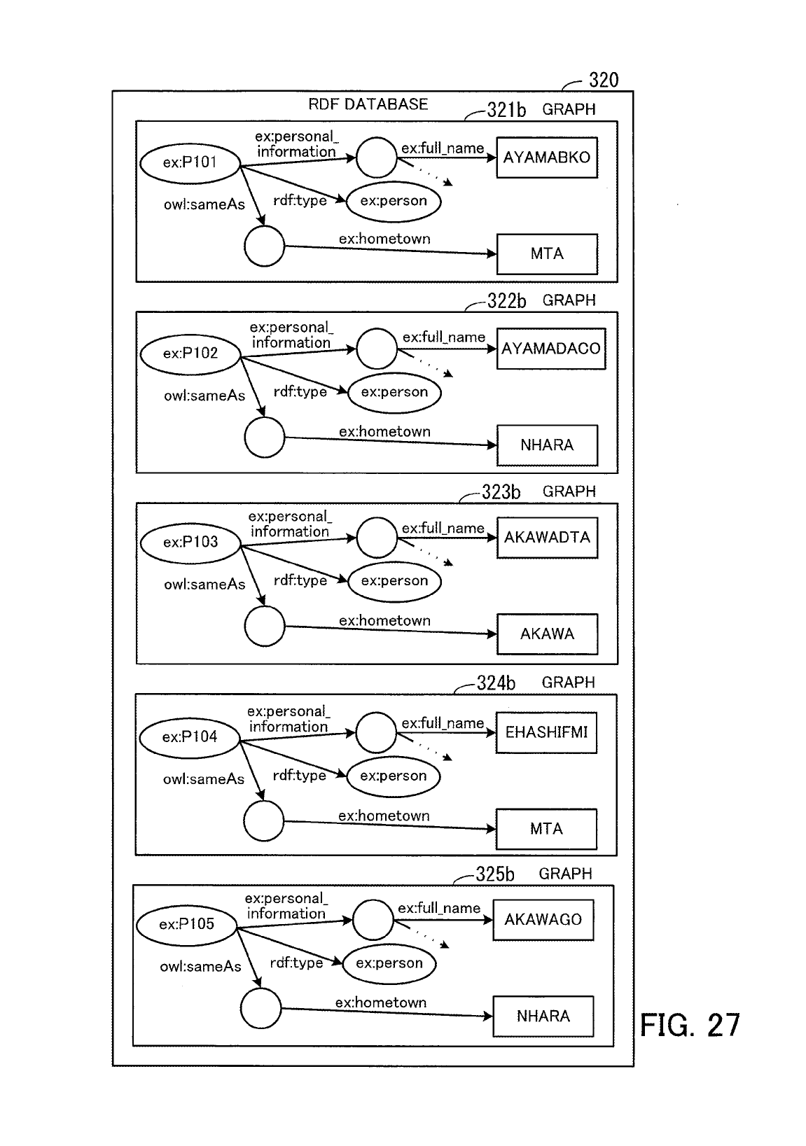

FIG. 27 illustrates a second update example of the RDF data. In the example in FIG. 27, character strings are newly associated by a property path “ex:hometown” in the graph 321b to 325b. If one of the added hometown names indicates the same character string as the family name of the corresponding person, the added value happens to be the same as the value in the corresponding tuple. For example, the hometown of the person corresponding to “ex:P103” in the graph 323b is “AKAWA,” which is the same as the estimated value “AKAWA” in the tuple including “ex:P103” registered in the tuple table 111 in FIG. 7. However, as the RDF data as a whole, since this is only the addition of the hometown of the person, it is appropriate that the developer not be notified of the property path.

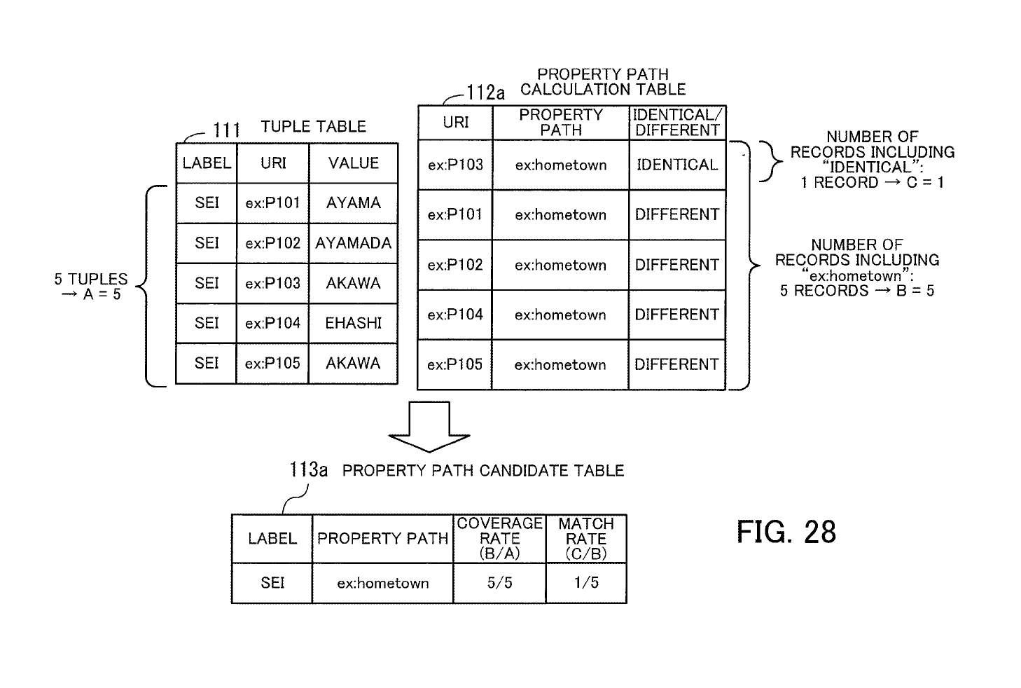

FIG. 28 illustrates a coverage rate and match rate calculation example based on the second update example of the RDF data. The example in FIG. 28 assumes that the threshold for the coverage rate is 0.65 and the threshold for the match rate is 0.6. As illustrated in FIG. 28, while the coverage rate in the example in FIG. 27 is 5/5, which is more than its threshold, the match rate is 1/5, which is less than its threshold. Thus, the notification unit 140 does not notify the terminal apparatus 200 of the property path.

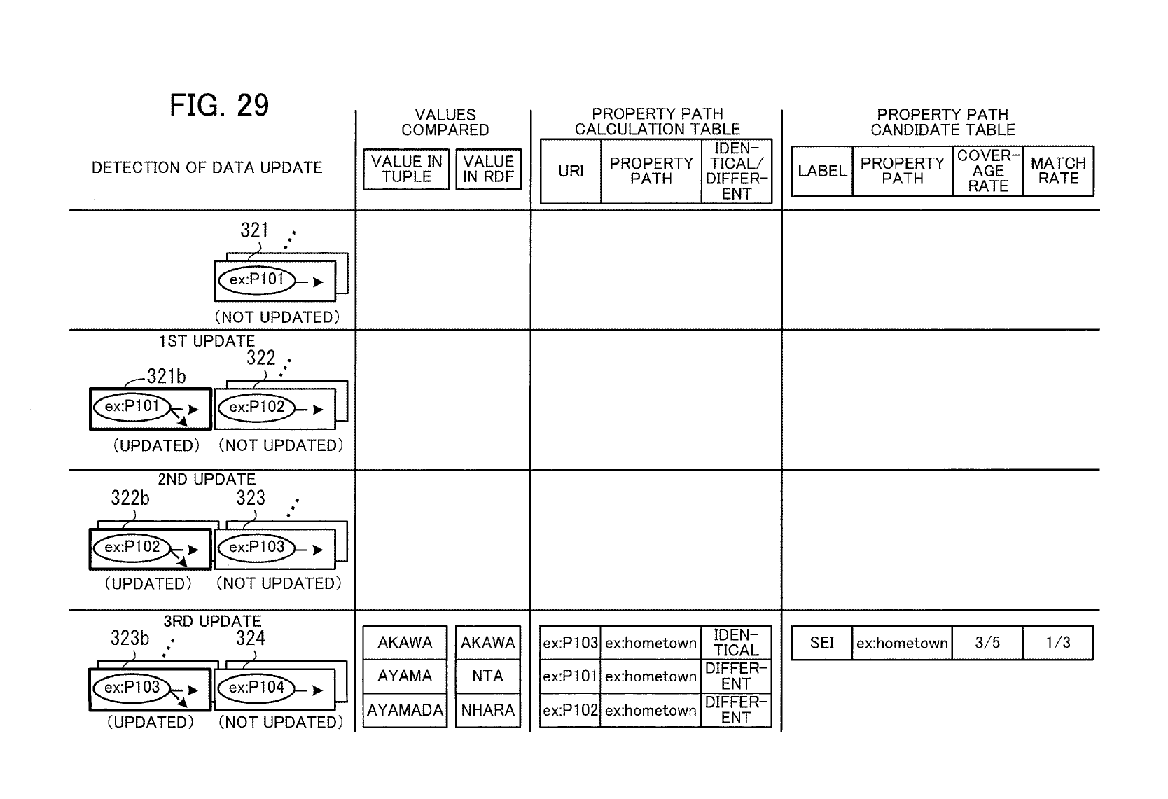

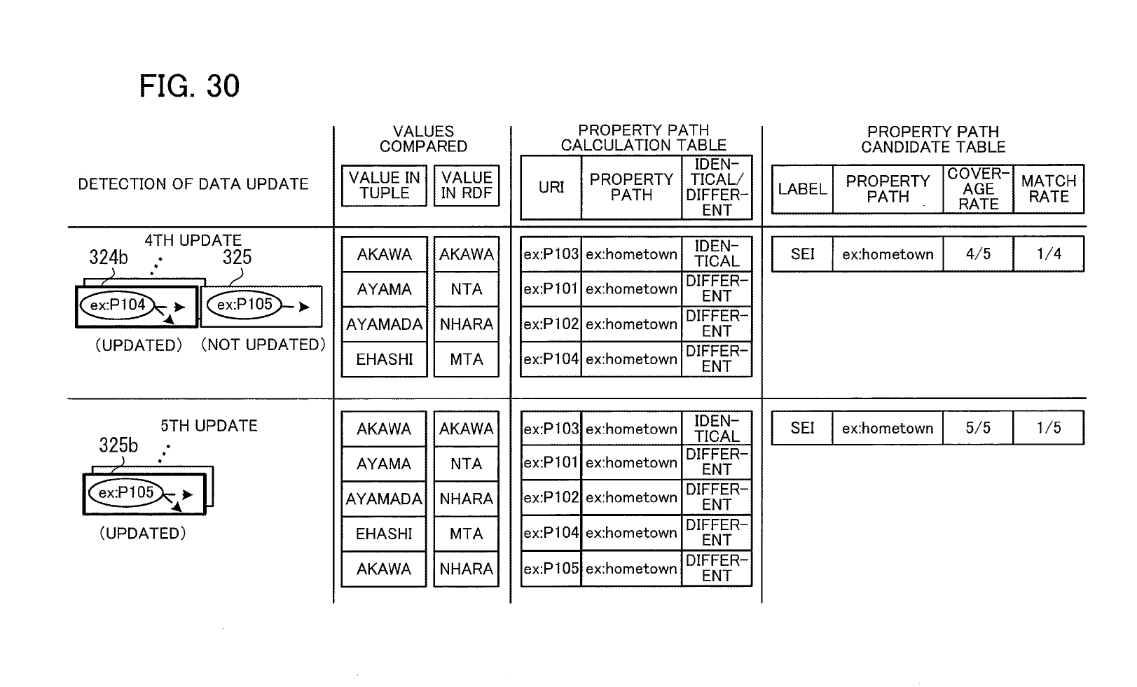

While FIG. 28 illustrates the coverage rate and the match rate after all the graphs 321 to 325 are updated to the graphs 321b to 325b, FIGS. 29 and 30 illustrate the coverage rates and the match rates when the graphs 321 to 325 are sequentially updated to the graphs 321b to 325b one by one.

FIGS. 29 and 30 illustrate coverage rate and match rate calculation results per data update based on the second update example of the RDF data. FIG. 29 illustrates update results from first to third data updates.

In the first data update, a value different from that in the tuple in the graph 321 is newly associated by the property path “ex:hometown,” and the graph 321 is updated to the graph 321b. After the first data update, since the same value as that in the tuple does not exist, neither the coverage rate nor the match rate is calculated.

In the second data update, a value different from that in the tuple in the graph 322 is newly associated by the property path “ex:hometown,” and the graph 322 is updated to the graph 322b. After the second data update, since the same value as that in the tuple does not exist, neither the coverage rate nor the match rate is not calculated.

In the third data update, the same value as that in the tuple in the graph 323 is newly associated by the property path “ex:hometown,” and the graph 323 is updated to the graph 323b. After the third data update, the coverage rate is 3/5, and the match rate 1/3.

FIG. 30 illustrates update results from fourth and fifth data updates.

In the fourth data update, a value different from that in the tuple in the graph 324 is newly associated by the property path “ex:hometown,” and the graph 324 is updated to the graph 324b. After the fourth data update, the coverage rate is 4/5, and the match rate 1/4.

In the fifth data update, a value different from that in the tuple in the graph 325 is newly associated by the property path “ex:hometown,” and the graph 325 is updated to the graph 325b. After the fifth data update, the coverage rate is 5/5, and the match rate 1/5.

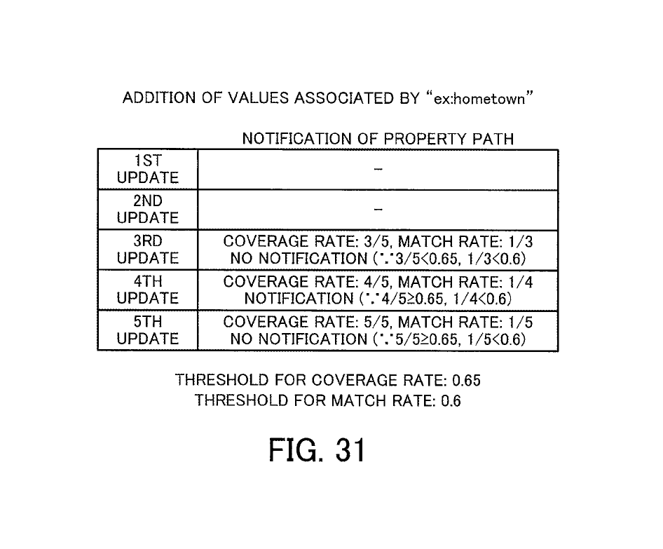

FIG. 31 illustrates a property path notification determination example based on the second update example of the RDF data. The example in FIG. 31 assumes that the threshold for the coverage rate is 0.65 and the threshold for the match rate is 0.6.

Since neither the coverage rate nor the match rate is calculated in the first and second data updates illustrated in FIG. 29, notification determination is not performed for the first and second data updates. As a result of the third data update illustrated in FIG. 29, both the coverage rate and the match rate are less than their respective thresholds. Thus, the notification unit 140 determines not to notify the terminal apparatus 200 of the property path. As a result of the fourth data update illustrated in FIG. 30, while the coverage rate is more than its threshold, the match rate is less than its threshold. Thus, the notification unit 140 determines not to notify the terminal apparatus 200 of the property path. As a result of the fifth data update illustrated in FIG. 30, while the coverage rate is more than its threshold, the match rate is less than threshold. Thus, the notification unit 140 determines not to notify the terminal apparatus 200 of the property path.

In this way, in the second update example of the RDF data, the notification unit 140 does not notify the terminal apparatus 200 of the property path. Namely, when a data update in which a value different from the value that the developer wishes to use is added, the notification unit 140 does not notify the terminal apparatus 200 of the property path.

There are cases in which the coverage rate remains below its threshold while the match rate is brought to be equal to or more than its threshold, depending on the update content of the RDF data.

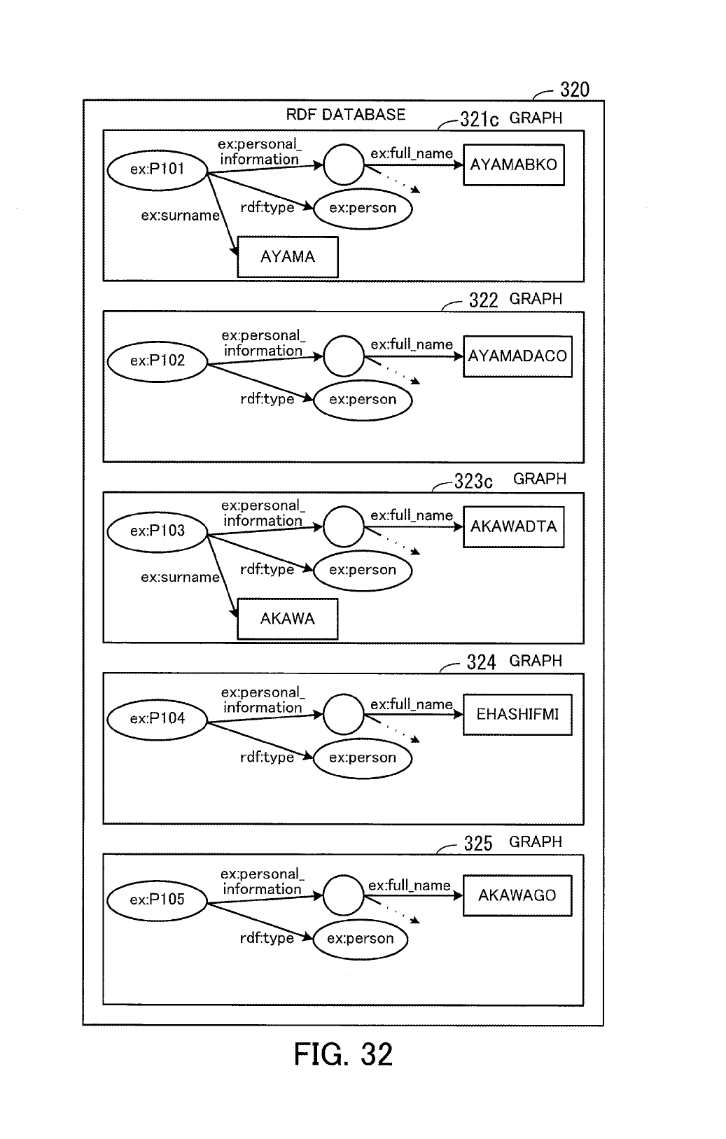

FIG. 32 illustrates a third update example of the RDF data. In the example in FIG. 32, character strings are newly associated by a property path “ex:surname” in the graph 321c and 323c. Since only the graphs 321c and 323c have been updated, even when the developer wishes to use the values associated by the property path “ex:surname” in application software, a sufficient number of values are not acquired. Thus, it is appropriate that the developer not be notified of the property path.

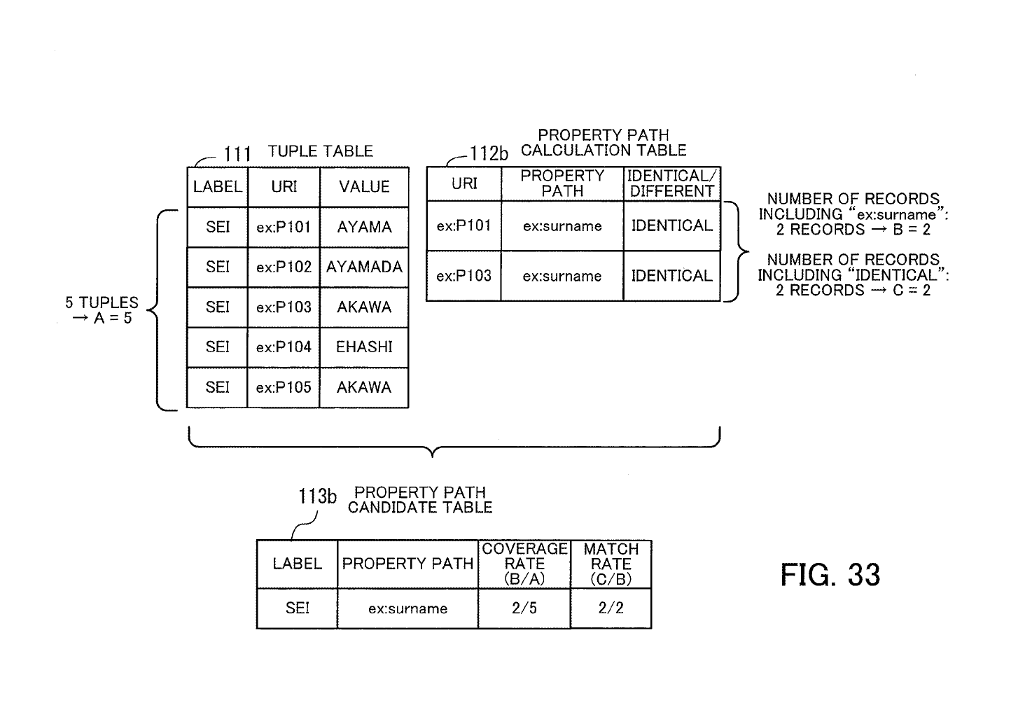

FIG. 33 illustrates a coverage rate and match rate calculation example based on the third update example of the RDF data. The example in FIG. 33 assumes that the threshold for the coverage rate is 0.65 and the threshold for the match rate is 0.6. As illustrated in FIG. 33, while the match rate in the example in FIG. 32 is 2/2, which is more than its threshold, the coverage rate is 2/5, which is less than its threshold. Thus, the notification unit 140 does not notify the terminal apparatus 200 of the property path.

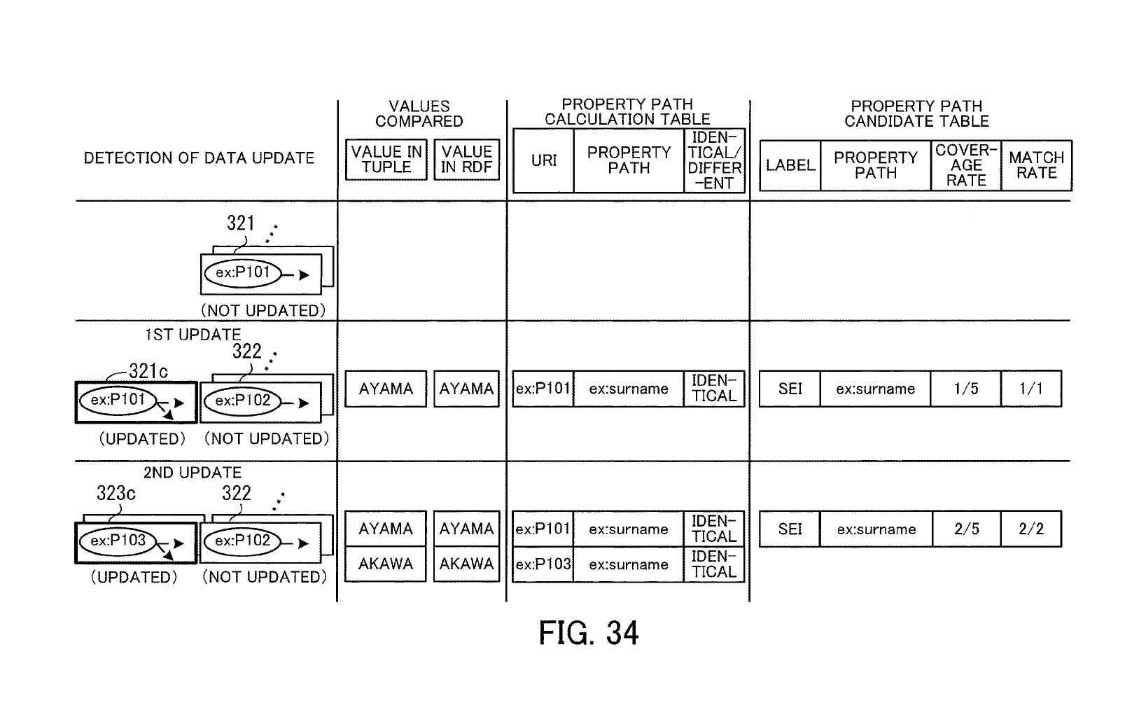

While FIG. 33 illustrates the coverage rate and the match rate after both the graphs 321 and 323 are updated to the graphs 321c to 323c, FIGS. 34 illustrates the coverage rates and the match rates when the graphs 321 and 323 are sequentially updated to the graphs 321c to 323c one by one.

FIG. 34 illustrates coverage rate and match rate calculation results per data update based on the third update example of the RDF data.

In the first data update, the same value as that in the tuple is in the graph 321 newly associated by the property path “ex:surname,” and thus, the graph 321 is updated to the graph 321c. After the first data update, the coverage rate is 1/5, and the match rate 1/1.

In the second data update, the same value as that in the tuple in the graph 323 is newly associated by the property path “ex:surname,” and thus, the graph 323 is updated to the graph 323c. After the second data update, the coverage rate is 2/5, and the match rate 2/2.

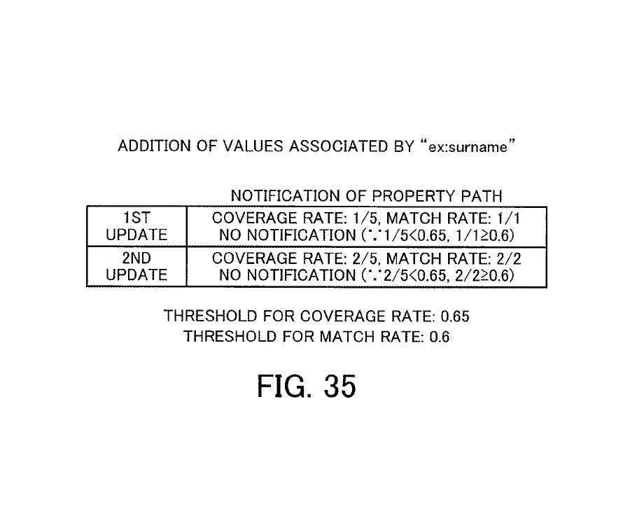

FIG. 35 illustrates a property path notification determination example based on the third update example of the RDF data. The example in FIG. 35 assumes that the threshold for the coverage rate is 0.65 and the threshold for the match rate is 0.6.

As a result of the first data update illustrated in FIG. 34, while the match rate is more than its threshold, the coverage rate is less than its threshold. Thus, the notification unit 140 determines not to notify the terminal apparatus 200 of the property path. As a result of the second data update illustrated in FIG. 34, while the match rate is more than its threshold, the coverage rate is still less than its threshold. Thus, the notification unit 140 determines not to notify the terminal apparatus 200 of the property path.

In this way, in the third update example of the RDF data, the notification unit 140 does not notify the terminal apparatus 200 of the property path. Namely, even when a data update in which the same value as that that the developer wishes to use is added, unless a sufficient number of values are added, the notification unit 140 does not notify the terminal apparatus 200 of the property path.

As described above, the second embodiment takes the advantage of the feature that RDF data has a graph structure. Namely, by following a single property path in a graph, from any URI belonging to a certain category, a desired value could be obtained. The property path candidate notification apparatus 100 searches for a value obtained by following a single property path, determines whether there is a value, and determines whether the value is the same as the corresponding estimated value. In this way, only when both the coverage rate and the match rate are high, the property path candidate notification apparatus 100 notifies the terminal apparatus 200 of the corresponding property path. Consequently, unnecessary notification is prevented, and the developer's burden on monitoring the update status is reduced. For example, in the case of the example illustrated in FIG. 24 to FIG. 26, if the developer is notified of the property path per data update, the developer is notified of the property path five times. In contrast, according to the second embodiment, the developer is notified of the property path only once.

### Third Embodiment

Next, a third embodiment will be described.

In the above second embodiment, when the developer transmits more tuples, the statistical reliability of the coverage rate and the match rate is improved. However, transmitting many tuples could be a burden on the developer. For example, while it is preferable that an automatic tuple transmission function be embedded in the ad hoc module, there are cases in which such a function fails to be embedded due to the processing efficiency or the like. In such cases, the developer needs to manually transmit tuples. However, manually transmitting a large number of tuples is not realistic.

Thus, according to the third embodiment, to reduce the developer's burden on the transmission without deteriorating the statistical reliability so much, a URI-selection SPARQL search query (which will simply be referred to as a search query) is used. Namely, as the URIs processed by the property path calculation unit 130, URIs acquired by a search query are also used in addition to the URIs in the tuples in the tuple table 111.

Hereinafter, the third embodiment will be described in detail with a focus on the difference from the second embodiment.

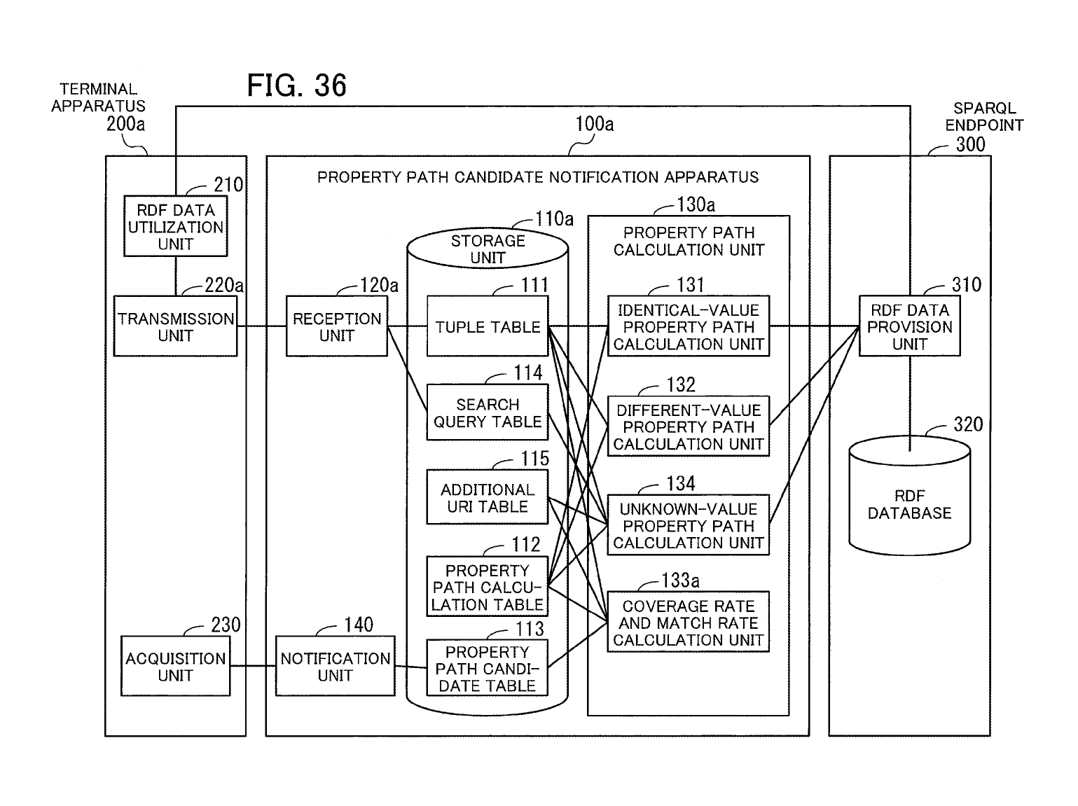

FIG. 36 is a block diagram illustrating functions of individual apparatuses according to the third embodiment. Since the second and third embodiments include like elements as illustrated in FIGS. 4 and 36, these elements will be denoted by like reference characters, and description thereof will be omitted.

A transmission unit 220a of a terminal apparatus 200a transmits not only tuples but also a search query to a property path candidate notification apparatus 100a. For example, the transmission unit 220a acquires a search query for URIs used in processing from the RDF data utilization unit 210. Next, the transmission unit 220a associates the acquired search query with a label and transmits the search query and the label to the property path candidate notification apparatus 100a. The transmission unit 220a may transmit a search query inputted by the developer to the property path candidate notification apparatus 100a.

A reception unit 120a of the property path candidate notification apparatus 100a receives the tuples and the search query from the terminal apparatus 200a. The reception unit 120a registers the received tuples in the tuple table 111 and the received search query in a search query table 114.

A storage unit 110a holds the search query table 114 and an additional URI table 115, in addition to the data tables held in the storage unit 110 according to the second embodiment. The search query table 114 is a data table holding the above search query. The additional URI table 115 is a data table holding the URIs acquired by the search query.

A property path calculation unit 130a includes an unknown-value property path calculation unit 134, in addition to the functions of the property path calculation unit 130 according to the second embodiment. The unknown-value property path calculation unit 134 acquires URIs from the SPARQL endpoint 300 by using the search query. The unknown-value property path calculation unit 134 searches for a value associated with a URI that is not registered in the tuple table 111 of all the acquired URIs by a property path registered in the property path calculation table 112. If the unknown-value property path calculation unit 134 finds a value, the unknown-value property path calculation unit 134 registers “unknown” under the “identical/different” column for the acquired URI in the property path calculation table 112.

In addition, a coverage rate and match rate calculation unit 133a according to the third embodiment calculates the coverage rate in view of the number of URIs registered in the additional URI table 115. In addition, the coverage rate and match rate calculation unit 133a calculates the match rate in view of the number of URIs associated with “unknown” under the “identical/different” column in the property path calculation table 112.

The lines connecting various elements illustrated in FIG. 36 represent only some of the communication paths. Communication paths other than those in FIG. 36 may also be set. For example, the function of each individual element illustrated in FIG. 36 may be realized by causing a computer to execute a program module corresponding to that element.

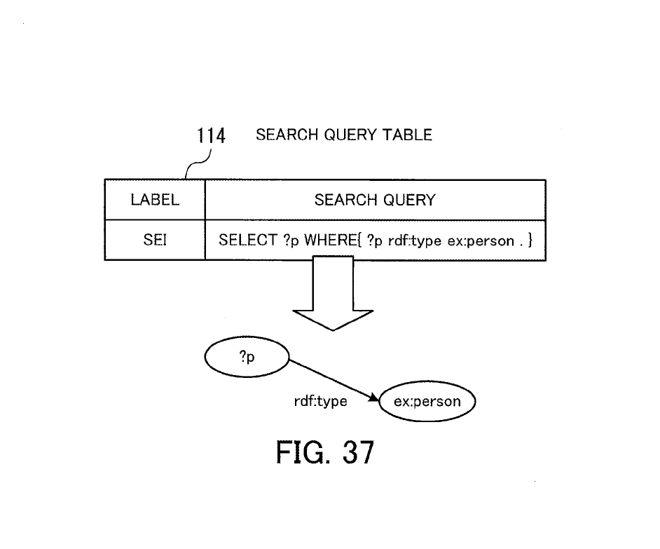

FIG. 37 illustrates an example of the search query table 114. A search query transmitted from the terminal apparatus 200a is associated with a label and is then set in the search query table 114. The search query illustrated in FIG. 37 is a search query for acquiring URIs “?p” serving as subjects, such as URIs “ex:person” acquired by following a property “rdf:type.”

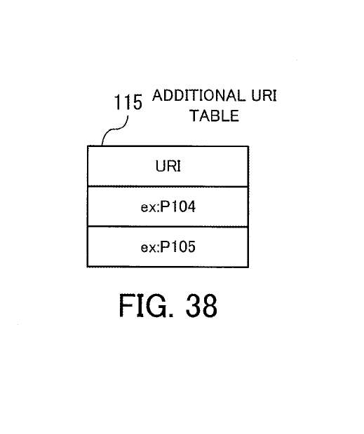

FIG. 38 illustrates an example of the additional URI table. The URIs that the unknown-value property path calculation unit 134 has acquired from the SPARQL endpoint 300 are set in the additional URI table 115.

Next, reception processing of the reception unit 120a according to the third embodiment will be described.

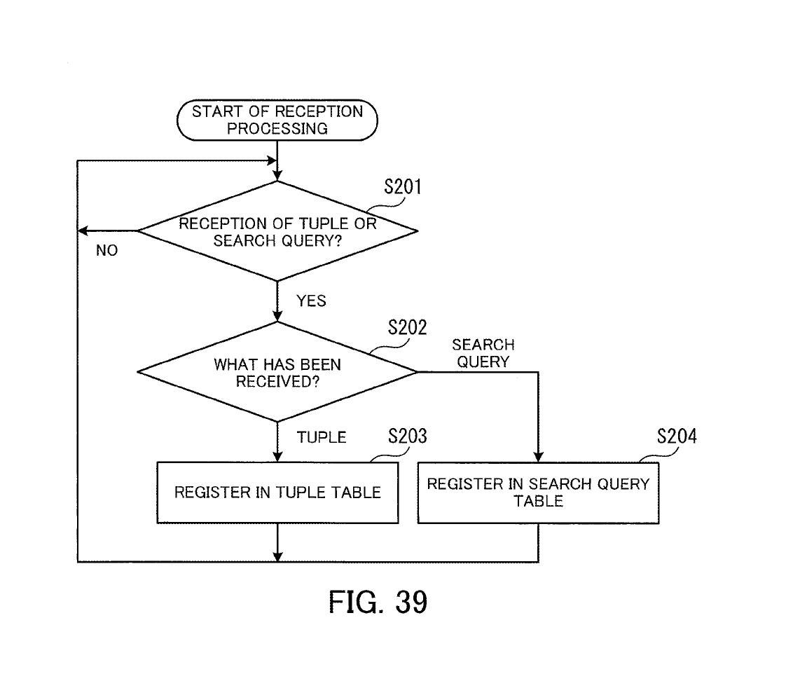

FIG. 39 is a flowchart illustrating an example of a procedure of reception processing. Hereinafter, the processing illustrated in FIG. 39 will be described step by step.

[Step S201] The reception unit 120a determines whether the reception unit 120a has received a tuple or a search query from the terminal apparatus 200a. If the reception unit 120a has received a tuple or a search query, the processing proceeds to step S202. If the reception unit 120a has not received neither a tuple nor a search query, the processing in step S201 is repeated. The received search query is given a label.

[Step S202] The reception unit 120a determines what has been received. If the reception unit 120a has received a tuple, the processing proceeds to step S203. If the reception unit 120a has received a search query, the processing proceeds to step S204.

[Step S203] The reception unit 120a registers the received tuple in the tuple table 111. Next, the processing returns to step S201.

[Step S204] The reception unit 120a registers the received search query and the label given thereto in the search query table 114. Next, the processing returns to step S201.

In this way, according to the third embodiment, the reception unit 120a receives a tuple or a search query. When receiving a tuple, the reception unit 120a registers the tuple in the tuple table 111. When receiving a search query, the reception unit 120a registers the search query in the search query table 114. Next, the property path calculation unit 130a performs property path calculation processing.

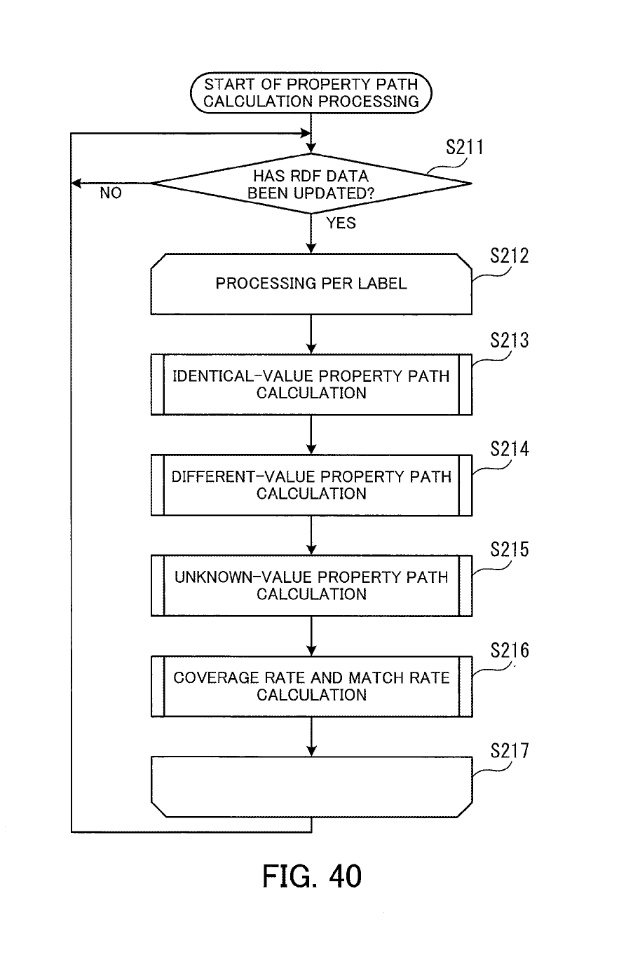

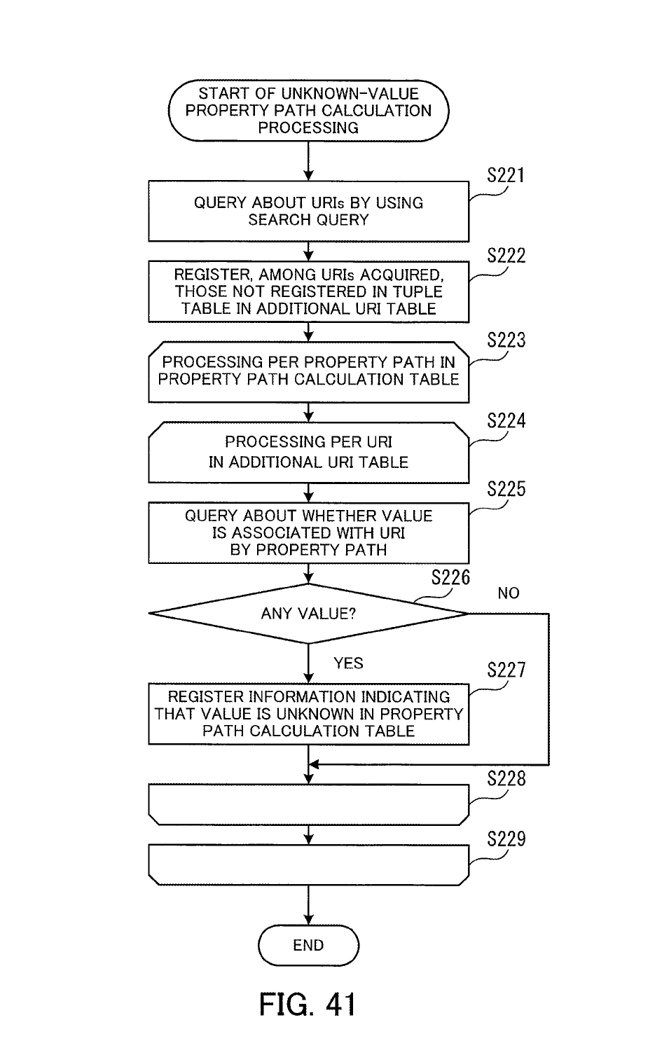

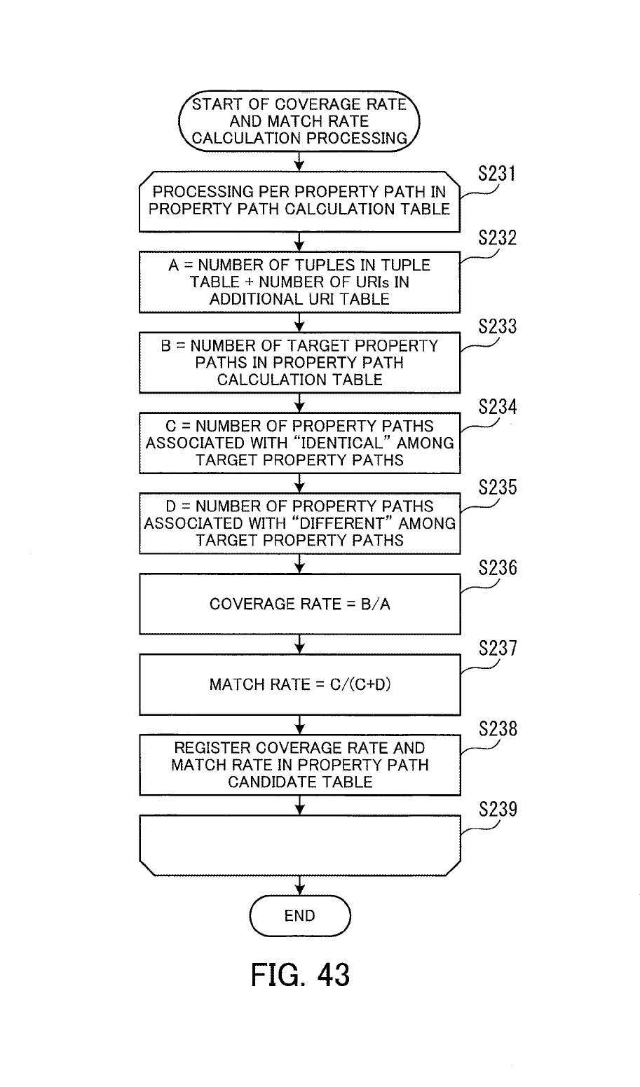

FIG. 40 is a flowchart illustrating an example of a procedure of property path calculation processing according to the third embodiment. In the processing illustrated in FIG. 40, steps S211 to S214 and step S217 are the same as steps S131 to S134 and S136 illustrated in FIG. 14, respectively. Hereinafter, steps S215 and S216 different from the steps in FIG. 14 will be described.

[Step S215] The property path calculation unit 130a causes the unknown-value property path calculation unit 134 to perform unknown-value property path calculation processing, which will be described in detail below with reference to FIG. 41.

[Step S216] The property path calculation unit 130a causes the coverage rate and match rate calculation unit 133a to perform coverage rate and match rate calculation processing, which will be described in detail below with reference to FIG. 43.

Next, the unknown-value property path calculation processing will be described in detail.

FIG. 41 is a flowchart illustrating an example of a procedure of the unknown-value property path calculation processing. Hereinafter, the processing illustrated in FIG. 41 will be described step by step.

[Step S221] The unknown-value property path calculation unit 134 queries the SPARQL endpoint 300 about URIs by using the search query registered in the search query table 114, the search query being associated with a label. In response to this query, the SPARQL endpoint 300 searches the RDF database 320 for URIs matching the search query and transmits the matching URIs.

[Step S222] Among the URIs acquired from the SPARQL endpoint 300, the unknown-value property path calculation unit 134 registers the URIs that are not registered in the tuple table 111 in the additional URI table 115.

[Step S223] The unknown-value property path calculation unit 134 performs steps S224 to S228 per property path registered in the property path calculation table 112.

[Step S224] The unknown-value property path calculation unit 134 performs steps S225 to S227 per URI registered in the additional URI table 115.

[Step S225] The unknown-value property path calculation unit 134 queries the SPARQL endpoint 300 about whether a value is associated with a processing target URI by the processing target property path. When the SPARQL endpoint 300 receives the query, the RDF data provision unit 310 follows the property path from the specified URI and determines whether there is any value. Next, the RDF data provision unit 310 notifies the property path candidate notification apparatus 100a of presence or absence of a value.

[Step S226] If the unknown-value property path calculation unit 134 determines that a value is associated with the processing target URI by the processing target property path, the processing proceeds to step S227. If not, the processing proceeds to step S228.

[Step S227] The unknown-value property path calculation unit 134 registers information indicating that the value is unknown, the processing target URI, and the processing target property path in the property path calculation table 112.

[Step S228] After the unknown-value property path calculation unit 134 processes all the URIs in the additional URI table 115, the processing proceeds to step S229.

[Step S229] After processing all the property paths in the property path calculation table 112, the unknown-value property path calculation unit 134 ends the unknown-value property path calculation processing.

In this way, for the URIs that are not registered in the tuple table 111, information “unknown” is registered under the “identical/different” column in the property path calculation table 112.

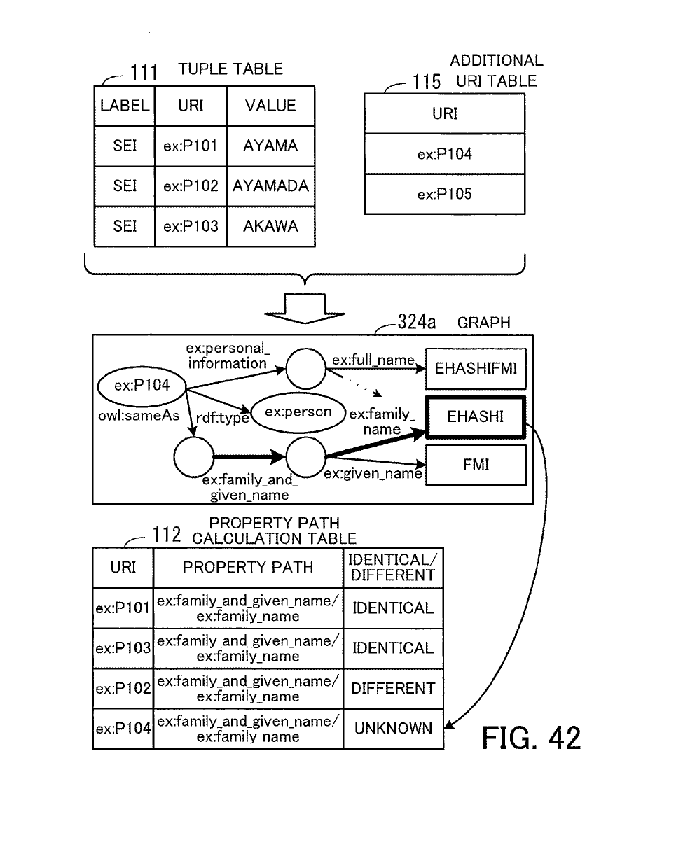

FIG. 42 illustrates an example of a result of the unknown-value property path calculation processing. The following example assumes that the RDF data as illustrated in FIG. 13 is registered in the RDF database 320. In the example in FIG. 42, three tuples are registered in the tuple table 111. In addition, as a result of the identical-value property path calculation processing and the different-value property path calculation processing, in the property path calculation table 112, information about “identical” or “different” obtained by following the property path “ex:family_and_given_name/ex:family_name” is set for each of the URIs “ex:P101” to “ex:P103.”

Next, the unknown-value property path calculation processing is performed. Referring to FIG. 13, it is seen that the root URIs in the graphs 321a to 324a and 325 match the search query registered in the search query table 114. Thus, in response to the query using the search query, the SPARQL endpoint 300 transmits the URIs “ex:P101” to “ex:P105” to the property path calculation unit 130a. Since the URIs “ex:P101” to “ex:P103” are already registered in the tuple table 111, the other URIs “ex:P104” and “ex:P105” are registered in the additional URI table 115.

The value “EHASHI” is associated with the URI “ex:P104,” which is registered in the additional URI table 115, by the property path “ex:family_and_given_name/ex:family_name” in the graph 324a. Thus, a record including information “unknown” under the “identical/different” column is registered in the property path calculation table 112, the information being associated with the URI “ex:P104” and the property path “ex:family and given name/ex:family name.”

However, no value is associated with the URI “ex:P105,” which is registered in the additional URI table 115, by the property path “ex:family_and_given_name/ex:family_name” in the graph 325 (see FIG. 13). Thus, no record is added in the property path calculation table 112 for the URI “ex:P105.”

After the unknown-value property path calculation processing, coverage rate and match rate calculation processing is performed.

FIG. 43 is a flowchart illustrating an example of a procedure of coverage rate and match rate calculation processing according to the third embodiment.

[Step S231] The coverage rate and match rate calculation unit 133a performs steps S232 to S238 per property path registered in the property path calculation table 112.

[Step S232] The coverage rate and match rate calculation unit 133a sets a sum of the number of tuples registered in the tuple table 111 and the number of URIs registered in the additional URI table 115 to a variable A.

[Step S233] The coverage rate and match rate calculation unit 133a sets the number of processing target property paths registered in the property path calculation table to a variable B.

[Step S234] Among the processing target property paths registered in the property path calculation table 112, the coverage rate and match rate calculation unit 133a sets the number of property paths associated with “identical” under the “identical/different” column to a variable C.

[Step S235] Among the processing target property paths registered in the property path calculation table 112, the coverage rate and match rate calculation unit 133a sets the number of property paths associated with “different” under the “identical/different” column to a variable D.

[Step S236] The coverage rate and match rate calculation unit 133a determines that a result obtained by dividing the variable B by the variable A (B/A) to be the coverage rate.

[Step S237] The coverage rate and match rate calculation unit 133a determines that a result obtained by dividing the variable C by a sum of the variables C and D (C/(C+D)) to be the match rate.

Since the sum of the variables C and D is equal to the number of tuples including the processing target labels in the tuple table 111, the number of tuples including the processing target labels in the tuple table 111 may be used as the denominator of the match rate, instead of the sum of the variables C and D.

[Step S238] The coverage rate and match rate calculation unit 133a registers the calculated coverage rate and match rate in the property path candidate table 113.

[Step S239] After processing all the property paths, the coverage rate and match rate calculation unit 133a ends the coverage rate and match rate calculation processing.

In this way, the coverage rate and the match rate are calculated.

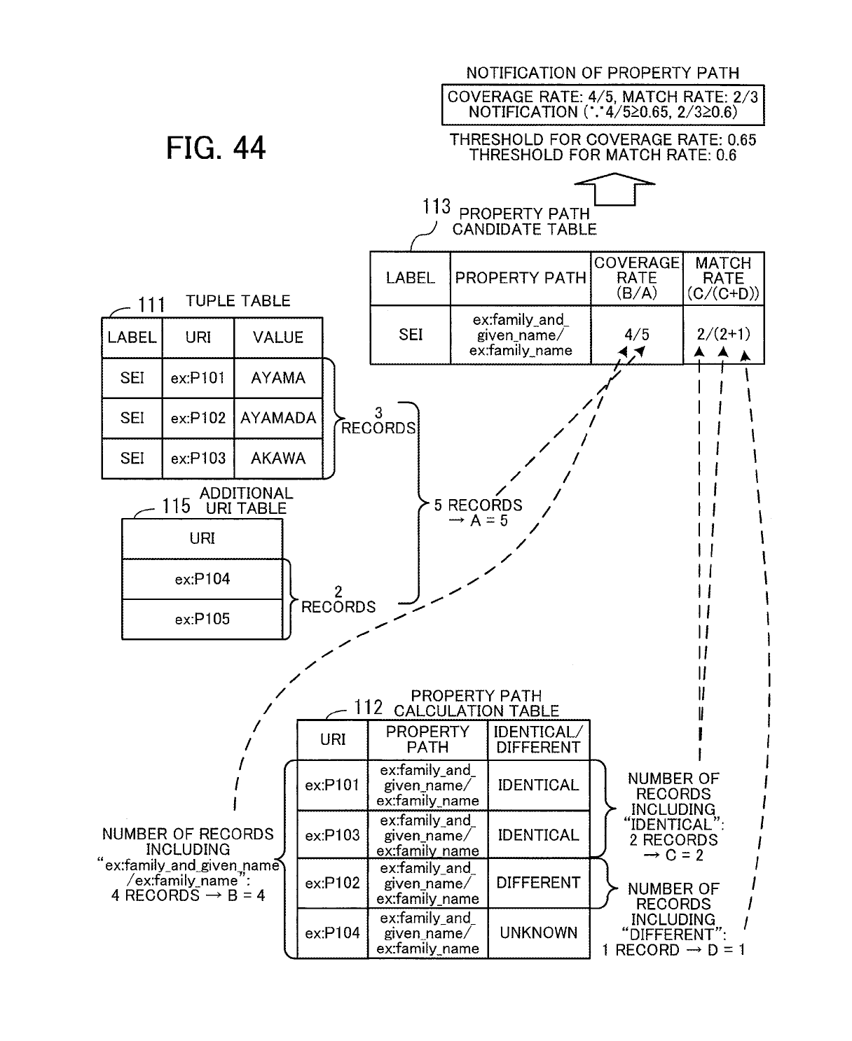

FIG. 44 illustrates a coverage rate and match rate calculation example. In the example in FIG. 44, three tuples are registered in the tuple table 111, and two URIs are registered in the additional URI table 115. Thus, A=5. In addition, since four property paths “ex:family_and_given_name/ex:family_name” are registered in the property path calculation table 112, B=4. In addition, since two of the property paths “ex:family_and_given_name/ex:family_name” in the property path calculation table 112 are associated with “identical” under the “identical/different” column, C=2. Since one of the property paths “ex:family_and_given_name/ex:family_name” in the property path calculation table 112 is associated with “different” under the “identical/different” column, D=1. As a result, the coverage rate is 4/5 and the match rate 2/3.

If, as in the second embodiment, the thresholds for the coverage rate and the match rate are 0.65 and 0.6, respectively, the notification unit 140 notifies the terminal apparatus 200a of the property path “ex:family_and_given_name/ex:family_name.”

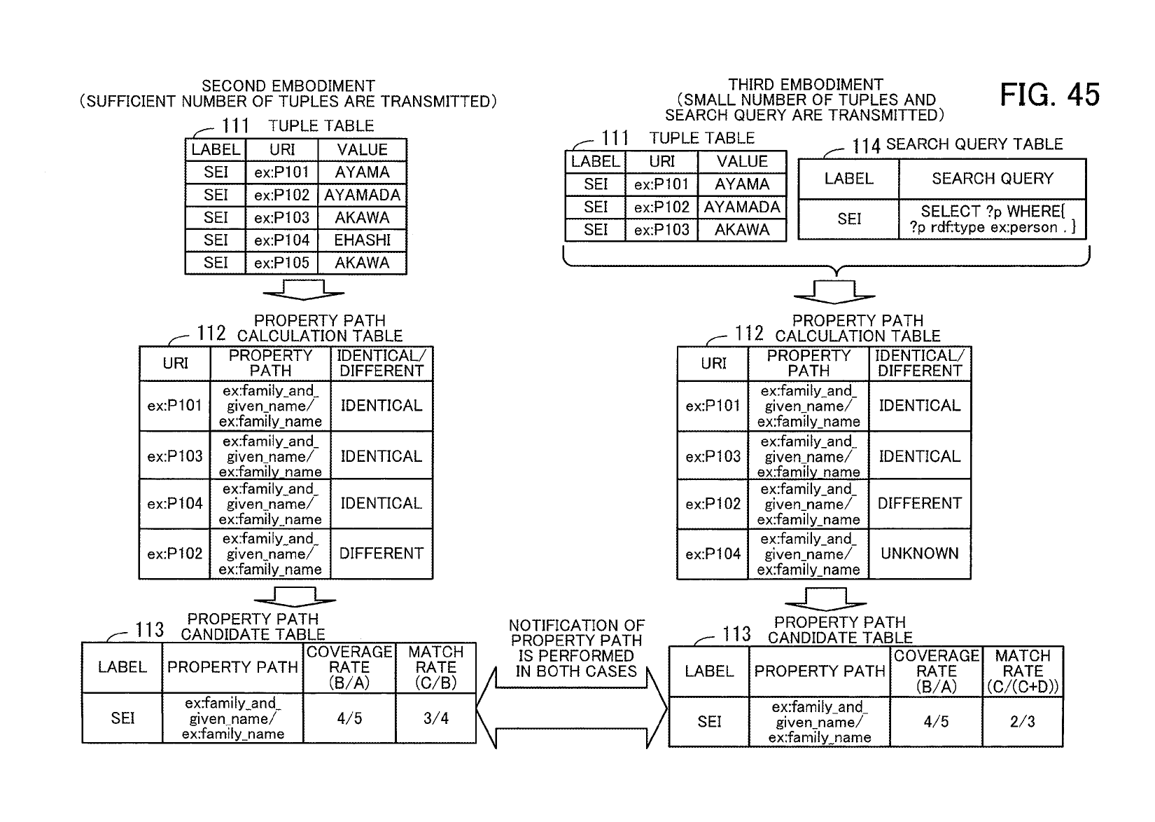

FIG. 45 illustrates a first comparison example between a coverage rate and a match rate according to the second embodiment and those according to the third embodiment. A coverage rate and match rate calculation example according to the second embodiment is illustrated on the left side in FIG. 45, and a coverage rate and match rate calculation example according to the third embodiment is illustrated on the right side in FIG. 45. The following description assumes that the RDF data has been updated as illustrated in FIG. 13.

According to the second embodiment, a sufficient number of tuples are transmitted (five tuples in the example in FIG. 45), and the coverage rate 4/5 and the match rate 3/4 are obtained. In contrast, according to the third embodiment, a small number of tuples (three tuples in the example in FIG. 45) and a search query are transmitted. If there are URIs matching the search query, the number of URIs are added to the denominator A of the coverage rate. In addition, among the URIs newly detected by the search query, if there are URIs each of which is associated with a value by the corresponding property path, the number of URIs is added to the numerator B of the coverage rate. As a result, the coverage rate 4/5 and the match rate 2/3 are obtained.

According to the third embodiment, since a small number of tuples are transmitted, the denominator of the match rate is small. Consequently, while the reliability of the match rate is worse than that according to the second embodiment, since use of the search query makes the denominator A of the coverage rate larger than the number of tuples transmitted, similar reliability to that according to the second embodiment is obtained for the coverage rate. As a result, according to the third embodiment, as in the second embodiment, when a sufficient number of target values that the developer wishes to use are added to the RDF data, the developer is notified of the property path leading to the added values.

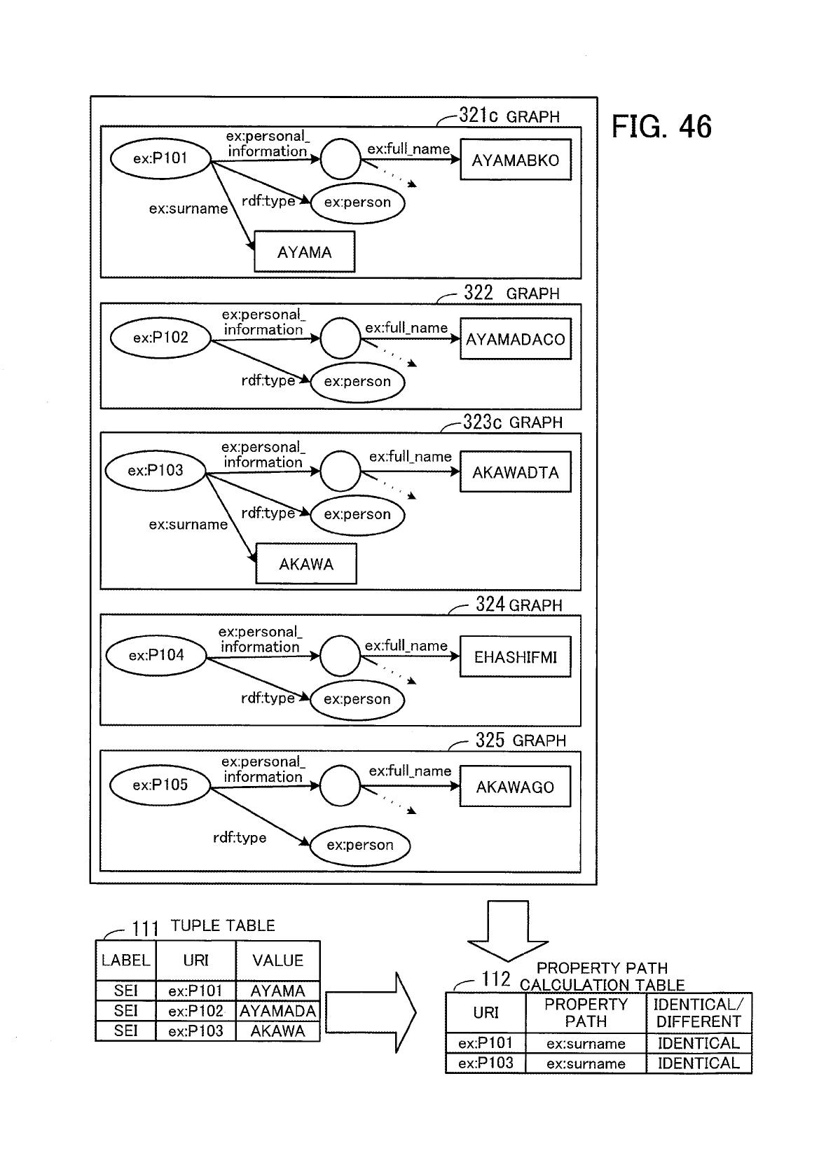

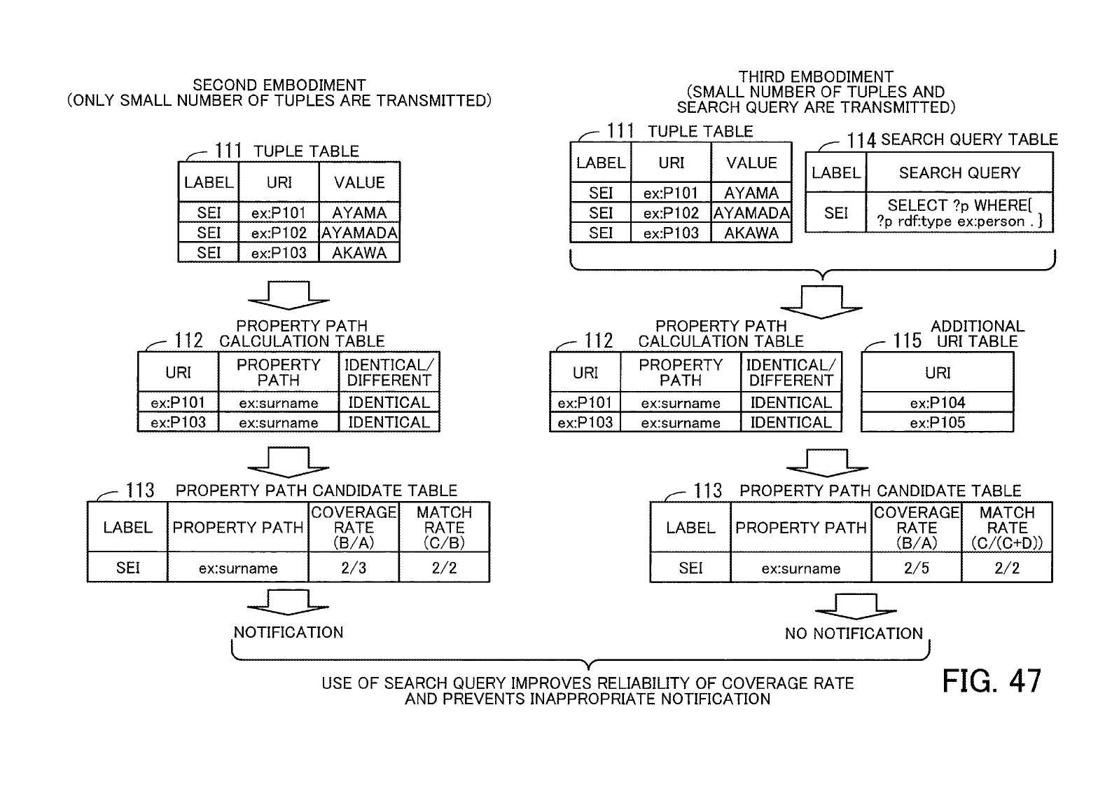

The example in FIG. 45 assumes that a sufficient number of tuples are transmitted in the processing according to the second embodiment. If a small number of tuples are transmitted, the reliability of the coverage rate is deteriorated according to the second embodiment. However, by using a search query as in the third embodiment, the deterioration of the reliability of the coverage rate is prevented. Hereinafter, the advantageous effect of maintaining the reliability of the coverage rate even when a smaller number of tuples are transmitted according to the third embodiment will be described with reference to FIGS. 46 and 47.

FIG. 46 illustrates an example of a property path calculation table when a small number of values are added to the RDF data. As illustrated in FIG. 46, the graphs 321 and 323 in the RDF database 320 have been updated to the graphs 321c and 323c. In this case, when only three tuples including the URIs “ex:P101” to “ex:P103” are transmitted, only two records corresponding to the two URIs “ex:P101” and “ex:P103” are registered in the property path calculation table 112. The contents registered in the property path calculation table 112 are the same between the second embodiment and the third embodiment.

Next, the difference in the coverage rate and the match rate between the second embodiment and the third embodiment when the property path calculation table 112 illustrated in FIG. 46 is generated will be described.

FIG. 47 illustrates a second comparison example between a coverage rate and a match rate according to the second embodiment and those according to the third embodiment. A coverage rate and match rate calculation example according to the second embodiment is illustrated on the left side in FIG. 47, and a coverage rate and match rate calculation example according to the third embodiment is illustrated on the right side in FIG. 47.

According to the second embodiment, since a small number of tuples are transmitted, the coverage rate is 2/3, and the match rate is 2/2. If the threshold for the coverage rate is 0.65, and the threshold for the match rate is 0.6, according to the second embodiment, the notification unit 140 determines to notify the developer of the property path although only a smaller number of values have been added to the RDF data.

In contrast, according to the third embodiment, while only a small number of tuples have been transmitted, since a search query is additionally used, the coverage rate is 2/5, and the match rate is 2/2. As a result, since the coverage rate is below its threshold, the notification unit 140 determines not to notify the developer of the property path.

In this way, according to the third embodiment, since a search query is used, the reliability of the coverage rate is improved, and inappropriate notification is prevented.

As described above, according to the third embodiment, many URIs are acquired by a search query, the statistical reliability of the coverage rate is improved. Since the terminal apparatus 200a needs to transmit only a small number of tuples, the developer's burden is reduced.

### Fourth Embodiment

Next, a fourth embodiment will be described. While the third embodiment improves the reliability of the coverage rate, if a small number of tuples are transmitted, the statistical reliability of the match rate is deteriorated. Thus, the fourth embodiment reduces the developer's burden on transmitting tuples, without deteriorating the statistical reliability at all. More specifically, instead of acquiring a small number of tuples and a search query from the developer, the property path candidate notification apparatus acquires an ad hoc module and a search query.

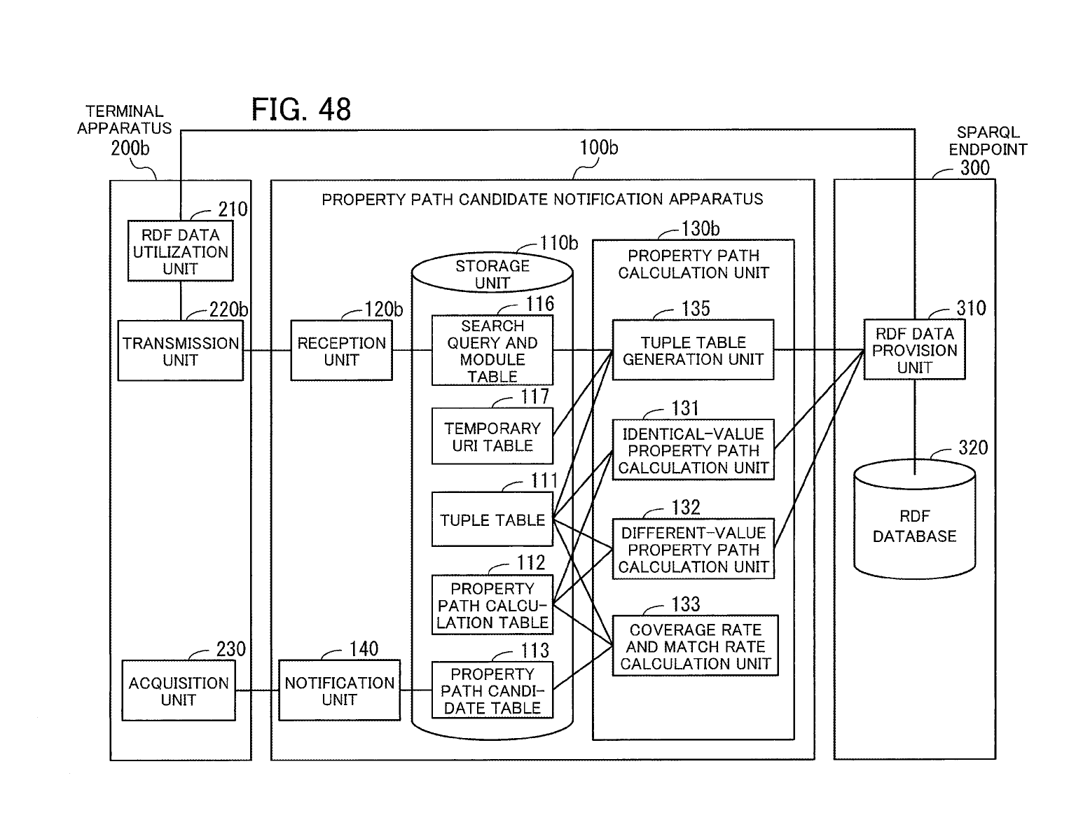

FIG. 48 is a block diagram illustrating functions of individual apparatuses according to a fourth embodiment. Since the second and fourth embodiments include like elements as illustrated in FIGS. 4 and 48, these elements will be denoted by like reference characters, and description thereof will be omitted.

A transmission unit 220b of a terminal apparatus 200b transmits an ad hoc module and a search query to a property path candidate notification apparatus 100b, instead of tuples. For example, the transmission unit 220b associates an ad hoc module and a search query inputted by the developer with a label and transmits the associated information to the property path candidate notification apparatus 100b. Alternatively, the transmission unit 220b may transmit a search query acquired from the RDF data utilization unit to the property path candidate notification apparatus 100b.

A reception unit 120b of the property path candidate notification apparatus 100b receives the ad hoc module and the search query from the terminal apparatus 200b. The reception unit 120b registers the received ad hoc module and search query in a search query and module table 116.

A storage unit 110b holds a search query and module table 116 and a temporary URI table 117, in addition to the data tables held in the storage unit 110 according to the second embodiment. The search query and module table 116 is a data table holding an ad hoc module and a search query. The temporary URI table 117 is a data table holding the URIs acquired by the search query.

The property path calculation unit 130b includes a tuple table generation unit 135, in addition to the functions of the property path calculation unit 130 according to the second embodiment. The tuple table generation unit 135 uses the search query to acquire URIs from the SPARQL endpoint 300. In addition, the tuple table generation unit 135 generates tuples on the basis of the acquired URIs and by using the ad hoc module and registers the generated tuples in the tuple table 111.

The lines connecting various elements illustrated in FIG. 48 represent only some of the communication paths. Communication paths other than those in FIG. 48 may also be set. For example, the function of each individual element illustrated in FIG. 48 may be realized by causing a computer to execute a program module corresponding to that element.

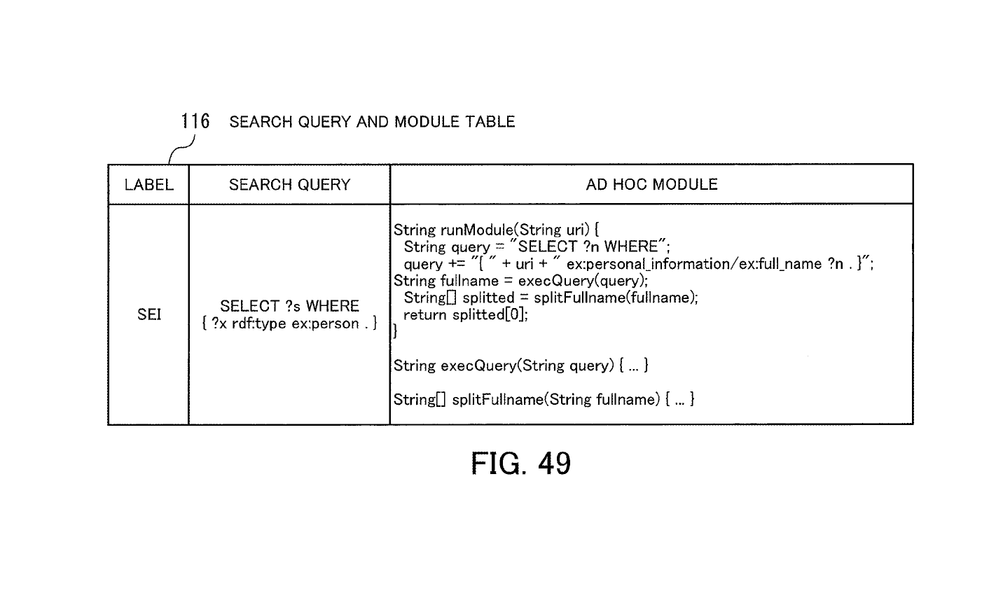

FIG. 49 illustrates an example of the search query and module table 116. The search query and module table 116 holds a label, a search query, and an ad hoc module, which are associated with each other. The search query indicates a condition for determining processing target URIs from the RDF data and is described in SPARQL. The ad hoc module is a program in which a processing procedure for estimating values that are not registered in the RDF data from certain values in the RDF data is described. For example, as illustrated in FIG. 11, the processing procedure for estimating a value indicating the family name of a person from a value indicating the full name of the person is described in the ad hoc module.

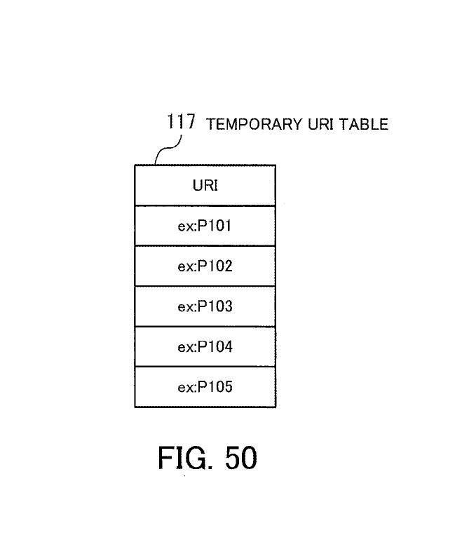

FIG. 50 illustrates an example of the temporary URI table. The temporary URI table 117 holds the URIs that the tuple table generation unit 135 has acquired from the SPARQL endpoint 300 by using the search query in the search query and module table 116.

Hereinafter, the processing that is performed by the property path calculation unit 130b and that is different from the second embodiment will be described in detail.

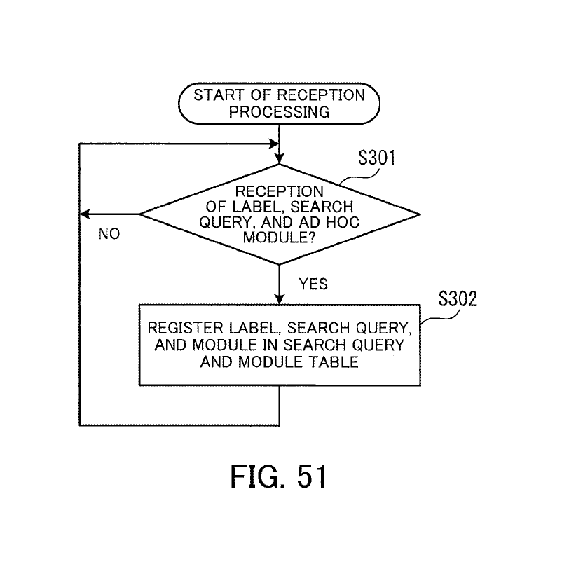

FIG. 51 is a flowchart illustrating an example of a procedure of reception processing according to the fourth embodiment. Hereinafter, the processing in FIG. 51 will be described step by step.

[Step S301] The reception unit 120b determines whether the reception unit 120b has received a set of a label, a search query, and an ad hoc module from the terminal apparatus 200b. If the reception unit 120b has received a set of a label, a search query, and an ad hoc module, the processing proceeds to step S302. If not, step S301 is repeated.

[Step S302] The reception unit 120b registers the received set of a label, a search query, and an ad hoc module in the search query and module table 116 as a single record.

In this way, the property path candidate notification apparatus 100b acquires a search query and an ad hoc module from the terminal apparatus 200b. Next, the property path calculation unit 130b performs property path calculation processing.

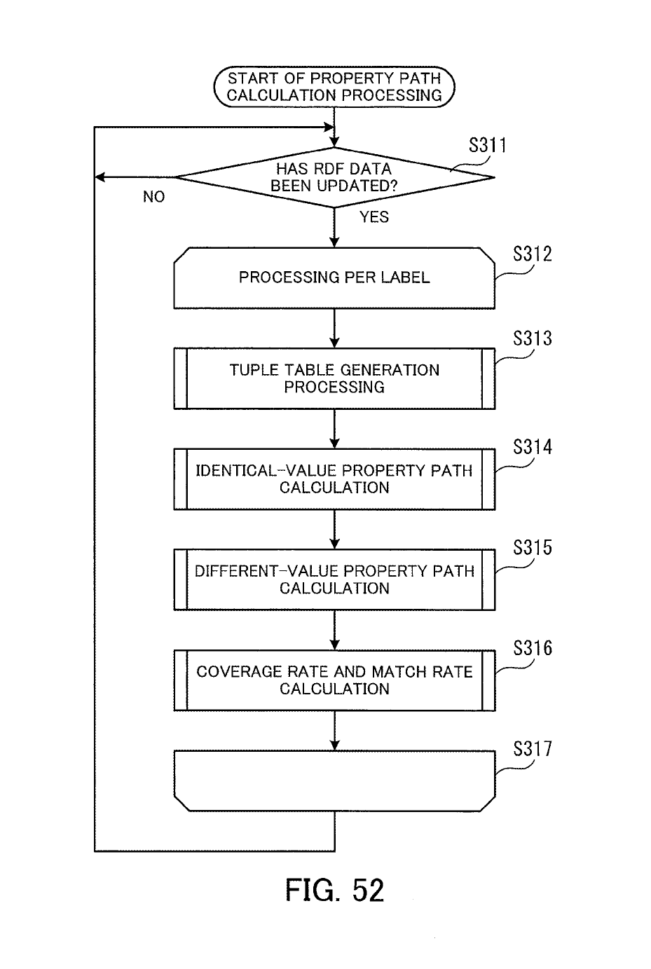

FIG. 52 is a flowchart illustrating an example of a procedure of property path calculation processing according to the fourth embodiment. In the processing in

FIG. 52, steps S311 and S312 and S314 to S317 are the same as steps S131 to S136 in FIG. 14, respectively. Hereinafter, step S313, which is absence in FIG. 14, will be described.

[Step S313] The property path calculation unit 130b causes the tuple table generation unit 135 to perform tuple table generation processing.

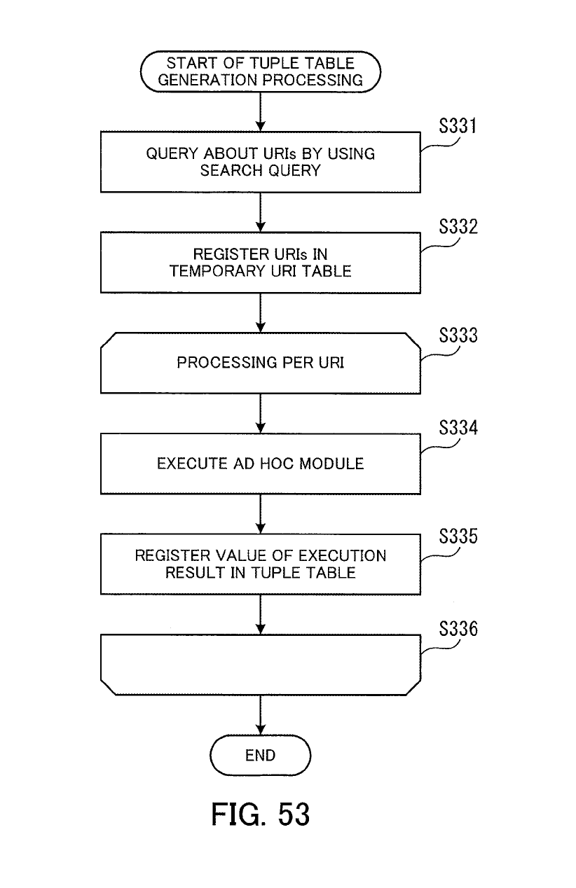

FIG. 53 is a flowchart illustrating an example of a procedure of tuple table generation processing. Hereinafter, the processing in FIG. 53 will be described step by step.

[Step S331] The tuple table generation unit 135 reads the search query associated with the label from the search query and module table 116 and queries the SPARQL endpoint 300 about URIs by using the search query. In response to the query, the SPARQL endpoint 300 searches the RDF database 320 for the URI matching the search query and transmits the matching URIs to the tuple table generation unit 135.

[Step S332] The tuple table generation unit 135 registers the URIs acquired from the SPARQL endpoint 300 in the temporary URI table 117.

[Step S333] The tuple table generation unit 135 performs steps S334 to S335 per URI registered in the temporary URI table 117.

[Step S334] The tuple table generation unit 135 reads the ad hoc module associated with the label from the search query and module table 116 and performs the ad hoc module by using the processing target URI as a parameter. By performing the ad hoc module, the tuple table generation unit 135 acquires a value associated with the processing target URI by a certain property path from the SPARQL endpoint 300, for example. Next, on the basis of the acquired value, the tuple table generation unit 135 acquires an estimated value of a target value that the developer wishes to use. For example, the tuple table generation unit 135 acquires an estimated value of the family name of a person from a value indicating the full name of the person.

[Step S335] The tuple table generation unit 135 associates the value acquired as a result of the execution of the ad hoc module with the label and the processing target URI and registers the associated information in the tuple table 111. If there is no execution result, the tuple table generation unit 135 does not register anything in the tuple table 111.

[Step S336] After processing all the URIs in the temporary URI table 117, the tuple table generation unit 135 ends the tuple table generation processing.

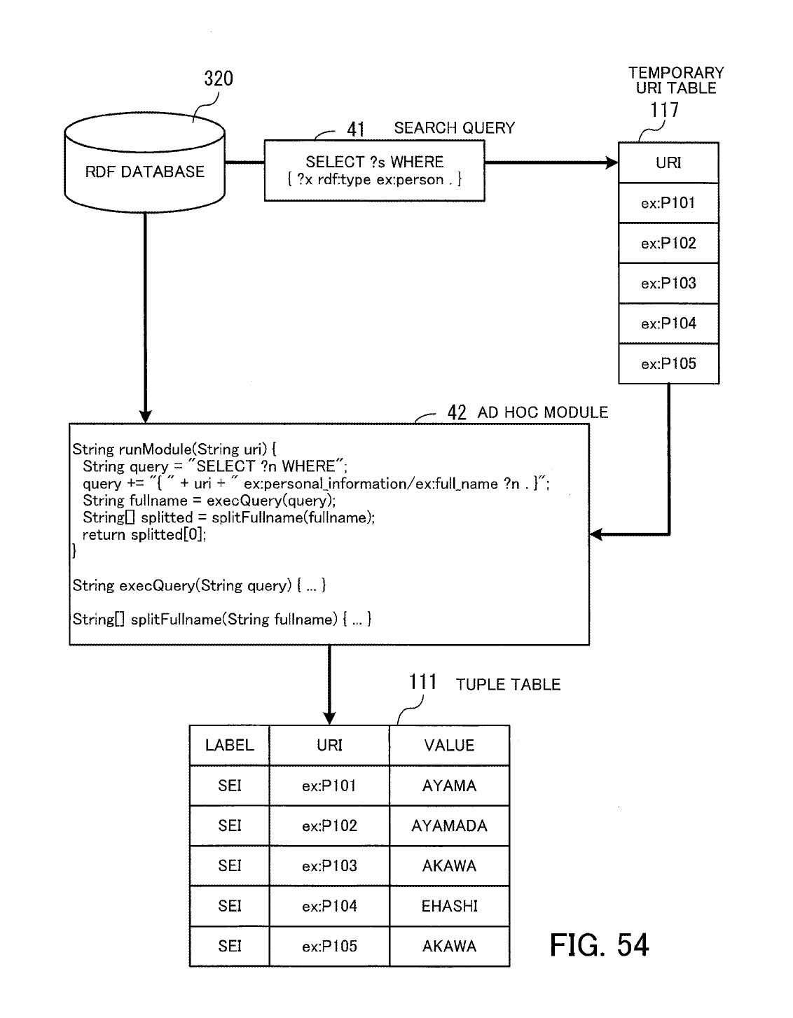

FIG. 54 illustrates a tuple table generation example. The example in FIG. 54 assumes that the RDF data as illustrated in FIG. 6 is stored in the RDF database 320. In this case, through the search processing by using a search query 41, five URIs “ex:P101” to “ex:P105” are acquired and stored in the temporary URI table 117. When an ad hoc module 42 performs processing on the URIs stored in the temporary URI table 117, values indicating “family names” are estimated from values indicating “full names,” and the estimated values are registered in the tuple table 111 as tuples. This example assumes that the ad hoc module 42 includes the family name dictionary 211 as illustrated in FIG. 11.

In this way, by using the search query 41 and the ad hoc module 42, tuples are registered in the tuple table 111, and the tuple table 111 having the same content as that according to the second embodiment is generated. The subsequent processing is the same as that according to the second embodiment.

According to the fourth embodiment, the developer does not transmit tuples but only an ad hoc module and a search query. However, the property path is still evaluated without deteriorating the statistical reliability of the match rate and the statistical reliability of the coverage rate. As a result, without causing a burden on the developer, the terminal apparatus 200b is notified of a property path leading to target values that the developer wishes to use at appropriate timing.

### Other Embodiments

While the property path candidate notification apparatuses 100, 100a, and 100b are arranged separately from the SPARQL endpoint 300 in the second to fourth embodiments, the property path candidate notification apparatuses 100, 100a, and 100b may be incorporated in other apparatuses. For example, any one of the property path candidate notification apparatus 100, 100a, and 100b may be incorporated inside the SPARQL endpoint 300.

In addition, in each of the second to fourth embodiments, the notification unit 140 notifies the corresponding terminal apparatus 200, 200a, or 200b of the property path only when both of the coverage rate and the match rate are equal to or more than their respective thresholds. However, when at least one of the coverage rate and the match rate is equal to or more than its threshold, the notification unit 140 may notify the corresponding terminal apparatus 200, 200a, or 200b of the property path.

Alternatively, a plurality of thresholds may be set for each of the coverage rate and the match rate. For example, a first threshold and a second threshold may be set for each of the coverage rate and the match rate. For example, the property path candidate notification apparatuses 100, 100a, and 100b perform a first notification when both the coverage rate and the match rate reach their respective first thresholds or more. The property path candidate notification apparatuses 100, 100a, and 100b perform a second notification when both of the coverage rate and the match rate reach their respective second thresholds or more.

According to one aspect, whether values included in a database are target values is evaluated.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a procedure comprising:
acquiring estimated values of values indicating certain features of a plurality of entities, respectively;
referring to a database holding the plurality of entities, the values indicating the features of the respective entities, and one or more items of relation information indicating a relationship between the plurality of entities and the values indicating the features of the respective entities, determining the plurality of entities to be first candidate entities, sequentially selecting one of the first candidate entities, determining with respect to the selected first candidate entity whether the same value as a first estimated value for the selected first candidate entity is found by following the relation information, and when the same value as the first estimated value is found, determining the relation information that leads to the same value as the first estimated value to be specified relation information and determining the selected first candidate entity to be a first entity;
referring to the database, determining, among the plurality of entities, entities other than first entities to be second candidate entities, sequentially selecting one of the second candidate entities, determining with respect to the selected second candidate entity whether a value different from a second estimated value for the selected second candidate entity is found by following the specified relation information, and determining, when a different value is found, the selected second candidate entity to be a second entity; and
calculating a concordance rate between the estimated values for the respective entities and the values associated with the respective entities by the specified relation information, based on the number of first entities and the number of second entities.

2. The non-transitory computer-readable storage medium according to claim 1, wherein the procedure further includes calculating an existence rate, which indicates a rate of the number of entities, each of which is associated with a value by the relation information, with respect to the number of the plurality of entities, based on the number of the plurality of entities, the number of first entities, and the number of second entities.

3. The non-transitory computer-readable storage medium according to claim 1, wherein the procedure further includes:
acquiring a search query indicating a common feature of the plurality of entities;
detecting one or more additional entities that match the search query in the database other than the plurality of entities;
referring to the database and determining, among the additional entities, entities, each of which is associated with a value by the specified relation information, to be third entities; and
calculating an existence rate, which indicates a rate of the number of entities, each of which is associated with a value by the relation information, with respect to the number of the plurality of entities, based on the number of the plurality of entities, the number of additional entities, the number of first entities, the number of second entities, and the number of third entities.

4. The non-transitory computer-readable storage medium according to claim 2, wherein the procedure further includes notifying another computer connected to the computer via a network of the specified relation information when the concordance rate and the existence rate satisfy a predetermined condition.

5. The non-transitory computer-readable storage medium according to claim 1,
wherein the procedure further includes acquiring a search query indicating a common feature of the plurality of entities and a program module for acquiring the estimated values of the values indicating the certain features of the plurality of entities based on values associated with the respective entities, and
wherein the acquiring of the estimated values includes using the search query to determine a plurality of entities in the database and executing the program module to acquire the estimated values for the determined respective entities.

6. A non-transitory computer-readable storage medium storing a computer program that causes a computer to perform a procedure comprising:
acquiring estimated values of values indicating certain features of a plurality of entities, respectively;
referring to a database holding the plurality of entities, the values indicating the features of the respective entities, and one or more items of relation information indicating a relationship between the plurality of entities and the values indicating the features of the respective entities, determining the plurality of entities to be candidate entities, sequentially selecting one of the candidate entities, determining with respect to the selected candidate entity whether the same value as an estimated value for the selected candidate entity is found by following the relation information, and determining, when the same value as the estimated value is found, the relation information that leads to the same value as the estimated value to be specified relation information; and
referring to the database, and calculating a concordance rate between the estimated values for the respective entities and the values associated with the respective entities by the specified relation information, based on the number of candidate entities, each of which is associated with the same value as a corresponding estimated value for the candidate entity, and the number of candidate entities, each of which is associated with a value different from a corresponding estimated value for the candidate entity.

7. An evaluation method comprising:
acquiring estimated values of values indicating certain features of a plurality of entities, respectively;
referring to, by a processor, a database holding the plurality of entities, the values indicating the features of the respective entities, and one or more items of relation information indicating a relationship between the plurality of entities and the values indicating the features of the respective entities, determining the plurality of entities to be first candidate entities, sequentially selecting one of the first candidate entities, determining with respect to the selected first candidate entity whether the same value as a first estimated value for the selected first candidate entity is found by following the relation information, and when the same value as the first estimated value is found, determining the relation information that leads to the same value as the first estimated value to be specified relation information and determining the selected first candidate entity to be a first entity;
referring to, by the processor, the database, determining, among the plurality of entities, entities other than first entities to be second candidate entities, sequentially selecting one of the second candidate entities, determining with respect to the selected second candidate entity whether a value different from a second estimated value for the selected second candidate entity is found by following the specified relation information, and determining, when a different value is found, the selected second candidate entity to be a second entity; and
calculating, by the processor, a concordance rate between the estimated values for the respective entities and the values associated with the respective entities by the specified relation information, based on the number of first entities and the number of second entities.
